(19) United States
(12) Patent Application Publication
(10) Pub. No.: US 2016/0186741 A1
(43) Pub. Date: Jun. 30, 2016

(54) CONTROL DEVICE FOR HIGH-PRESSURE PUMP

(71) Applicant: DENSO CORPORATION, Aichi (JP)

(72) Inventors: Yuuki SAKAMOTO, Kariya-city (JP); Tomoyuki TAKAGAWA, Kariya-city (JP)

(21) Appl. No.: 14/909,368

(22) PCT Filed: Jul. 14, 2014
(86) PCT No.: PCT/JP2014/003710

§ 371 Date: Feb. 1, 2016

(30) Foreign Application Priority Data
Aug. 2, 2013 (JP) 2013-161053
Feb. 28, 2014 (JP) 2014-038067

(51) Int. Cl. F04B 53/00; F04B 49/22; F04B 49/06; F02M 59/46; F04B 53/16; F02M 59/02; F02M 59/36; F04B 19/22; F04B 53/14

(52) U.S. Cl. CPC F04B 53/001; F04B 19/22; F04B 49/22; F04B 49/065; F04B 53/14; F04B 53/16; F02M 59/025; F02M 59/366; F02M 59/466

(57) ABSTRACT

A high-pressure pump includes a plunger and a control valve. An ECU adjusts a fuel discharge amount of the high-pressure pump by switching a valve opening and a valve closing of the control valve by the energization control of a coil. The ECU detects movement of the valve body with respect to a drive command of the valve opening or the valve closing of the control valve and executes an actuation determination of the high-pressure pump on the basis of a detection result. The ECU executes sound reduction control that reduces actuation sound of the high-pressure pump by controlling supply power supplied to the electromagnetic section on the basis of a determination result of the actuation determination in previous energization by the actuation determination section.

### CROSS REFERENCE TO RELATED APPLICATION

This application is based on and incorporates herein by reference Japanese Patent Applications No. 2013-161053 filed on Aug. 2, 2013 and Japanese Patent Applications No. 2014-38067 filed on Feb. 28, 2014.

### TECHNICAL FIELD

The present disclosure relates to a control device for a high-pressure pump.

### BACKGROUND ART

Conventionally, as a fuel supply system of an internal combustion engine, such as a gasoline engine or a diesel engine, a fuel supply system of an in-cylinder injection type that includes: a high-pressure pump for increasing pressure of low-pressure fuel that is pumped from a fuel tank to be high pressure; and a pressure accumulator chamber for storing high-pressure fuel that is pressure-fed from the high-pressure pump and that directly injects the high-pressure fuel in the pressure accumulator chamber from a fuel injection valve to inside of a cylinder of the internal combustion engine has been known. In addition, as the above high-pressure pump, a high-pressure pump that includes: a plunger that reciprocates within the cylinder; a pressurizing chamber into which the fuel from a low-pressure side is introduced; and a control valve of an electromagnetic drive type that adjusts a returning amount of the fuel introduced into the pressurizing chamber has been known.

As one example of the above high-pressure pump, the plunger is connected to a rotational shaft of an output shaft (a crankshaft) of the internal combustion engine, reciprocates within the cylinder when the rotational shaft rotates along with rotation of the crankshaft, and thus can change a volume of the pressurizing chamber. The control valve is an electromagnetic valve of a constantly open type, for example, and permits introduction of the fuel from a low-pressure side passage into the pressurizing chamber when a valve body is held at a valve opening position by a spring during non-energization of a solenoid coil. On the other hand, during energization of the coil, the valve body is displaced to a valve closing position by an electromagnetic force thereof and blocks the introduction of the fuel into the pressurizing chamber. In a state where the valve body of the control valve is at the valve opening position in a volume reduction stroke of the pressurizing chamber, a surplus of the fuel is returned from the pressurizing chamber to the low-pressure side in conjunction with movement of the plunger. Thereafter, when the valve body is controlled to be at the valve closing position by the energization of the coil, the fuel in the pressurizing chamber is pressurized by the plunger and discharged to a high-pressure side. In this way, discharge amount control of the high-pressure pump is executed.

During actuation of the control valve, collision sound may be produced when the valve body collides with a movement limiting member (a stopper), and the sound may give an occupant a sense of discomfort. In Patent Literature 1, various methods for reducing the collision sound between the valve body and the stopper in the discharge amount control of the high-pressure pump by the control valve are described. In Patent Literature 1, when the valve body moves to the valve closing position, the coil is energized at a minimum current value that is required to completely close the valve body. In this way, a time spent by the valve body to move to the valve closing position is extended, and a collision speed of the valve body with the stopper is reduced. Thereby, the collision sound is reduced.

In addition, in Patent Literature 1, in order to determine the above minimum current value, actual fuel pressure and target fuel pressure of the pressure accumulator chamber are compared, and the above minimum current value is determined on the basis of a current value at which a deviation of the actual fuel pressure from the target fuel pressure exceeds a threshold. In other words, when it is estimated that the current value applied to the coil is reduced and the actual fuel pressure of the pressure accumulator chamber falls below a lower limit value, it is estimated that complete closing of the control valve is not guaranteed. In addition, when the control valve is not completely closed, it is estimated that a fuel supply of the high-pressure pump is at least limited to such a degree that sufficiently high pressure can no longer be generated in the pressure accumulator chamber. In view of the above, in Patent Literature 1, the above minimum current value is determined on the basis of the current value at which the deviation of the actual fuel pressure from the target fuel pressure exceeds the threshold.

However, in the high-pressure pump, due to an individual difference or an environmental change, a variation in a fuel discharge amount with respect to the current value that is applied to the coil may be generated, and due to this variation, the fuel discharge amount may be increased or reduced from what is assumed. For this reason, when the actual fuel pressure and the target fuel pressure are compared and it is determined on the basis of a comparison result whether the fuel is discharged from the high-pressure pump (whether the pump is actuated), a relationship between the current value applied to the coil and an actuation state of the high-pressure pump at the current value may not accurately be comprehended. In addition, in the case where the minimum current value that is required to completely close the valve body is determined on the basis of the current value at a time that the deviation of the actual fuel pressure from the target fuel pressure exceeds the threshold, there is a case where a determined value is deviated from an original minimum current value and is larger than the original minimum current value. In such a case, actuation sound of the high-pressure pump becomes louder than loudness that can be realized.

### PRIOR ART LITERATURES

### Patent Literature

Patent Literature 1: JP2010-533820A

### SUMMARY OF INVENTION

The present disclosure has been made to solve the above problem and therefore has a purpose of providing a control device for a high-pressure pump that can reduce actuation sound of the high-pressure pump.

According to an aspect of the present disclosure, a high-pressure pump includes a plunger that reciprocates in conjunction with rotation of a rotational shaft so as to be able to change a volume of a pressurizing chamber, and a control valve that has a valve body disposed in a fuel suction passage that communicates with the pressurizing chamber and supplies/blocks fuel to/from the pressurizing chamber by displacing the valve body in an axial direction by energization control with respect to an electromagnetic section. A control device for the high-pressure pump adjusts a fuel discharge amount of the high-pressure pump by switching between a valve opening and a valve closing of the control valve by the energization control.

The control device for the high-pressure pump includes a movement detection section detecting movement of the valve body with respect to a drive command of the control valve, an actuation determination section making an actuation determination of the high-pressure pump on the basis of a detection result of the movement detection section, and an energization control section executing sound reduction control that reduces actuation sound of the high-pressure pump by controlling supply power supplied to the electromagnetic section on the basis of a determination result of the actuation determination in previous energization by the actuation determination section.

When the control device displaces the valve body of the control valve by the energization control of an electromagnetic valve so as to discharge the fuel from the high-pressure pump, a noise (actuation sound) is generated due to a collision between the valve body moving to a target position (e.g., valve-closing position) and other members. In this case, the actuation sound is relatively loud and is generated every time in an actuation of the high-pressure pump, it is possible that an occupant of the vehicle feels uncomfortable. The actuation sound of the high-pressure pump can be reduced by reducing an electrical energy supplied to the electromagnetic valve so as to slowly move the valve body. However, when the electrical energy applied to the coil is too low, the first valve body cannot move to the target position, and the high-pressure pump cannot be activated. Thus, it is preferable to control the high-pressure pump with a small electrical energy within a range where the high-pressure pump can be activated, so as to surely activate the high-pressure pump and reduce the actuation sound.

When the first valve body shows the normal movement with respect to the drive command of the control valve the high-pressure pump is immediately actuated in conjunction with the movement of the first valve body, and the fuel is discharged from the high-pressure pump. On the other hand, when the first valve body does not show the normal movement with respect to the drive command, the high-pressure pump is not actuated, and the fuel is not discharged from the high-pressure pump. Thus, according to a configuration for determining the actuation state of the high-pressure pump by monitoring the movement of the first valve body with respect to the drive command of the control valve, whether the high-pressure pump is actuated or not actuated with respect to the drive command can accurately be detected. In addition, because the actuation/non-actuation of the high-pressure pump with respect to the drive command can accurately be detected, the supply power to the electromagnetic section can be controlled with as low power as possible within a range where the high-pressure pump can be actuated. Thus, according to the above configuration, the noise that is generated during the actuation of the high-pressure pump can be suppressed to be as low as possible while the actuation thereof is maintained.

### BRIEF DESCRIPTION OF DRAWINGS

The above and other objects, features and advantages of the present disclosure will become more apparent from the following detailed description made with reference to the accompanying drawings. In the drawings:

FIG. 1 is a configuration diagram of an overall outline of a fuel supply system of an engine of a first embodiment.

FIG. 2A is a time chart of a behavior during actuation of a high-pressure pump.

FIG. 2B is a view of an operation of the high-pressure pump indicated by IIB in FIG. 2A.

FIG. 2C is a view of the operation of the high-pressure pump indicated by IIC in FIG. 2A.

FIG. 2D is a view of the operation of the high-pressure pump indicated by IID in FIG. 2A.

FIG. 2E is a view of the operation of the high-pressure pump indicated by IIE in FIG. 2A.

FIG. 3 is a time chart of a behavior during non-actuation of the high-pressure pump.

FIG. 4 includes time charts for depicting a method for detecting movement of a valve body on the basis of a current speed.

FIG. 5 is a time chart for explaining an overview of sound reduction control of the high-pressure pump.

FIG. 6 is a time chart for explaining an overview of the sound reduction control of the high-pressure pump.

FIG. 7 is a flowchart of a process procedure of the sound reduction control.

FIG. 8 is a flowchart of a process procedure of a movement detection process.

FIG. 9 is a flowchart of a process procedure of a pump actuation determination process.

FIG. 10 includes charts for indicating relationships among a valve closing required time, a discharge period, and energization start timing.

FIG. 11 is a graph of a relationship between a pump supply power and the valve closing required time.

FIG. 12 is a graph of a relationship between the pump supply power and the energization start timing.

FIG. 13 is a time chart in the case where the valve closing required time is variable.

FIG. 14 is a flowchart of a process procedure of energization timing computation process.

FIG. 15 is a chart of an overview of an abnormality diagnosis process of the high-pressure pump.

FIG. 16 is a flowchart of a process procedure of the pump abnormality diagnosis process.

FIG. 17 is a time chart of a specific aspect of learning control of an actuation limit current.

FIG. 18 is a flowchart of the sound reduction control and the leaning control of the actuation limit current.

FIG. 19 includes charts for indicating a relationship between the pump supply power and a vibration or actuation sound.

FIG. 20 is a chart of a relationship between the pump supply power and the actuation sound.

FIG. 21 is a table in which step numbers respectively correspond to the pump supply power.

FIG. 22 includes explanatory charts in the case where the pump supply power is controlled by changing a voltage level.

FIG. 23 includes explanatory charts in the case where the pump supply power is controlled by changing a current.

### DESCRIPTION OF EMBODIMENTS

Hereafter, referring to drawings, an embodiment of the present invention will be described. In addition, the substantially same parts and components are indicated with the same reference numeral in following embodiments.

### First Embodiment

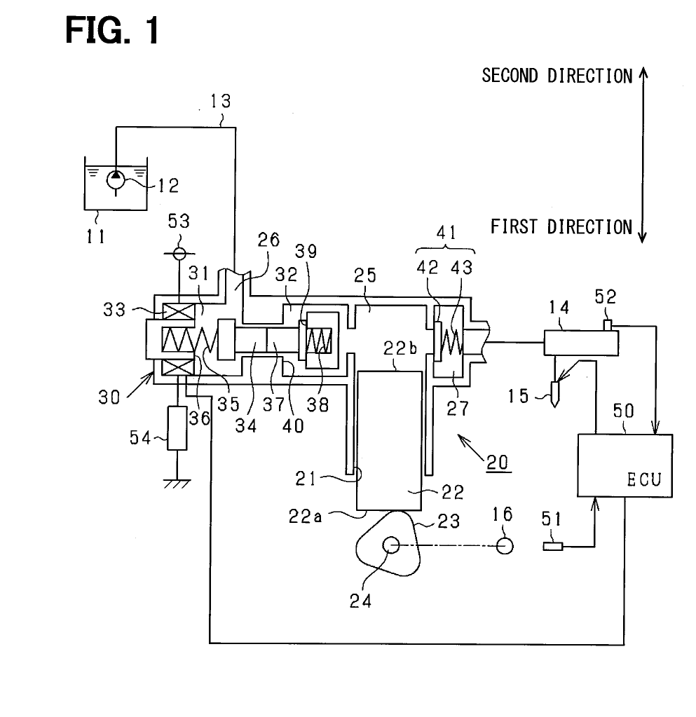

A description will hereinafter be made on a first embodiment in which the present disclosure is embodied with reference to the drawings. In this embodiment, a fuel supply system for supplying fuel to an on-vehicle gasoline engine of an in-cylinder injection type as an internal combustion engine is constructed. The system controls a fuel discharge amount of a high-pressure pump, a fuel injection amount of an injector, and the like with an electronic control unit (ECU) being a central part. An overall schematic configuration diagram of the system is depicted in FIG. 1.

A fuel tank 11 is provided in the fuel supply system of FIG. 1. Fuel stored in the fuel tank 11 is pumped by a low-pressure pump 12 of an electromagnetic drive type that corresponds to a feed pump, and is introduced into a high-pressure pump 20 via a low-pressure pipe 13. Pressure of the fuel that has been introduced in the high-pressure pump 20 is increased to be high pressure by the high-pressure pump 20 and is then pressure-fed to a pressure accumulator chamber 14. The high-pressure fuel that has been pressure-fed is stored in a high-pressure state in the pressure accumulator chamber 14, and is then directly injected into a cylinder from an injector 15 that is attached to each of the cylinders of the engine.

Next, the high-pressure pump 20 will be described. The high-pressure pump 20 of the system is configured as a plunger pump and performs suction and discharge of the fuel in conjunction with movement of a plunger.

More specifically, as depicted in FIG. 1, in the high-pressure pump 20, a cylinder 21 is disposed in a pump main body, and a plunger 22 is inserted in the cylinder 21 in a freely reciprocating manner in an axial direction. A first end 22a of the plunger 22 abuts against a cam 23 by an urging force of a spring, which is not depicted. The cam 23 has multiple cam ridges and is fixed to a camshaft 24 that rotates along with rotation of an output shaft (a crankshaft 16) of the engine. In this embodiment, the camshaft 24 is referred to as a rotational shaft 24. In this way, when the crankshaft 16 rotates during an operation of the engine, the plunger 22 can move within the cylinder 21 in the axial direction in conjunction with rotation of the cam 23.

A pressurizing chamber 25 is provided on a second end 22b of the plunger 22. The pressurizing chamber 25 communicates with a fuel suction passage 26 and a fuel discharge passage 27, and introduction/discharge of the fuel into/from the pressurizing chamber 25 are performed via these passages 26, 27. More specifically, when the plunger 22 moves in a first direction to increase a volume of the pressurizing chamber 25, in conjunction with the movement, low-pressure fuel in the low-pressure pipe 13 is introduced into the pressurizing chamber 25 via the fuel suction passage 26. In addition, when the plunger 22 moves in a second direction to reduce the volume of the pressurizing chamber 25, in conjunction with the movement, the fuel in the pressurizing chamber 25 is discharged from the pressurizing chamber 25 to the fuel discharge passage 27.

A control valve 30 for adjusting a fuel discharge amount of the high-pressure pump 20 is provided in a fuel entry portion of the high-pressure pump 20 that is on an upstream side of the pressurizing chamber 25. The control valve 30 is configured as an opening/closing valve that performs supply/blockage of the fuel to/from the pressurizing chamber 25 by displacing a valve body in an axial direction by energization control of a coil 33 as an electromagnetic section. The fuel suction passage 26 is provided on the inside of the control valve 30, and in the fuel suction passage 26, a first valve chamber 31 and a second valve chamber 32 are sequentially formed along a flow of the fuel.

A first valve body 34 that is displaced by non-energization/energization of the coil 33 is accommodated in the first valve chamber 31. The first valve body 34 is held at a valve opening position by a first spring 35 as an urging section during the non-energization of the coil 33, and is displaced against an urging force of the first spring 35 to a position (a valve closing position) to abut against a first stopper 36 as a movement limiting member for limiting movement of the first valve body 34 during the energization of the coil 33. A power supply 53 is connected to an input terminal side of the coil 33, and electricity is supplied from the power supply 53 to the coil 33.

A second valve body 37 that is coaxially disposed with the first valve body 34 is accommodated in the second valve chamber 32. The second valve body 37 can be displaced along with the movement of the first valve body 34. More specifically, when the first valve body 34 is at the valve opening position, the second valve body 37 is pressed by the first valve body 34 in the axial direction and is thereby held at a position (a valve opening position) to abut against a second stopper 39 as a movement limiting member for limiting movement of the second valve body 37 against an urging force of a second spring 38. In this state, the second valve body 37 separates from a valve seat 40, and the low-pressure pipe 13 and the pressurizing chamber 25 communicate with each other. Accordingly, the introduction of the low-pressure fuel into the pressurizing chamber 25 is permitted. On the other hand, when the first valve body 34 is at the valve closing position in conjunction with the energization of the coil 33, the second valve body 37 is released from being pressed by the first valve body 34, is thus seated on the valve seat 40 by the urging force of the second spring 38, and is held at the valve closing position. In this state, communication between the low-pressure pipe 13 and the pressurizing chamber 25 is brought into a blocked state, and the introduction of the low-pressure fuel into the pressurizing chamber 25 is blocked.

The pressurizing chamber 25 is connected to the pressure accumulator chamber 14 via the fuel discharge passage 27. In addition, a check valve 41 is provided in the middle of the fuel discharge passage 27. The check valve 41 includes a check valve main body 42 and a check valve spring 43, and the check valve main body 42 is displaced in an axial direction when fuel pressure in the pressurizing chamber 25 becomes at least equal to predetermined pressure. More specifically, when the fuel pressure in the pressurizing chamber 25 is lower than the predetermined pressure, the check valve main body 42 is brought into a state of being held at a valve closing position by an urging force of the check valve spring 43, and thus discharge of the fuel from the pressurizing chamber 25 to the fuel discharge passage 27 is blocked. Meanwhile, when the fuel pressure in the pressurizing chamber 25 becomes at least equal to the predetermined pressure, the check valve main body 42 is displaced (opened) against the urging force of the check valve spring 43, and the discharge of the fuel from the pressurizing chamber 25 to the fuel discharge passage 27 is permitted.

In addition to the above, the system is provided with various sensors, such as a crank angle sensor 51 for outputting a rectangular crank angle signal at every predetermined crank angle of the engine, a fuel pressure sensor 52 for detecting fuel pressure in the pressure accumulator chamber 14, and a current sensor 54 for detecting an output current of the coil 33. The output current of the coil 33 corresponds to a coil current that flows through the coil 33.

As it has been well known, an ECU 50 is constructed of a microcomputer formed of a CPU, a ROM, a RAM, and the like as a main body, and executes various types of engine control in accordance with an operation state of the engine at the time by executing various control programs stored in the ROM. That is, the microcomputer of the ECU 50 receives detection signals from the above-described various sensors and the like, computes control amounts of various parameters related to the operation of the engine on the basis of these detection signals, and controls driving of the injector 15 and the control valve 30 on the basis of the computation values.

In this embodiment, in order to bring actual fuel pressure that is detected by the fuel pressure sensor 52 to target fuel pressure, as discharge amount control of the high-pressure pump 20, feedback control that is based on a deviation of the actual fuel pressure from the target fuel pressure is executed. In this way, the fuel pressure in the pressure accumulator chamber 14 is controlled to become pressure (the target fuel pressure) that corresponds to the operation state of the engine. In addition, an energization amount of the coil 33 is adjusted by duty control.

The discharge amount control of the high-pressure pump 20 will further be described. The microcomputer of the ECU 50 adjusts the fuel discharge amount of the high-pressure pump 20 by controlling valve closing timing of the control valve 30. More specifically, the ECU 50 is connected to the coil 33 of the control valve 30 via a coil drive circuit, which is not depicted, and controls an application voltage and energization timing of the coil 33 by outputting a drive command of valve opening/valve closing of the control valve 30 to the coil drive circuit.

By the way, in the case where the valve opening/valve closing of the control valve 30 is switched so as to discharge the fuel from the high-pressure pump 20, there is a case where noise is generated due to collision of the first valve body 34 with the first stopper 36 and gives an occupant of the vehicle a sense of discomfort. Regarding such noise (actuation sound of the high-pressure pump 20), as electrical energy applied to the coil 33 is increased, the first valve body 34 moves toward the first stopper 36 at a higher speed. Accordingly, the energy during the collision is increased, and thus the actuation sound is also increased. In other words, the energy during the collision can be reduced by lowering the electrical energy applied to the coil 33 and reducing a moving speed of the first valve body 34. In this way, the actuation sound can also be reduced. Thus, in this embodiment, sound reduction control for reducing the actuation sound of the high-pressure pump 20 by reducing the speed at which the first valve body 34 moves toward the valve closing position is executed.

On the other hand, when the electrical energy applied to the coil 33 is too low, the first valve body 34 cannot move toward the coil 33 during the energization of the coil 33, and the control valve 30 cannot be switched to a valve closed state. In such a case, the high-pressure pump 20 is not actuated, and the fuel cannot be discharged from the high-pressure pump 20.

Thus, in this embodiment, as the sound reduction control for the high-pressure pump 20, pump supply power that is power supplied to the coil 33 is controlled on the basis of a determination result of whether the high-pressure pump 20 is actuated with respect to the drive command. More specifically, when it is determined that the high-pressure pump 20 is in a state of capable of being actuated in the last energization of the coil 33, power reduction control for reducing the pump supply power in the current energization by a predetermined amount from the pump supply power in the last energization is executed. When it is determined that the high-pressure pump 20 is in a state of non-actuation in the last energization, power increase control for increasing the pump supply power in the current energization by a predetermined amount from the pump supply power in the last energization is executed. In this way, while the fuel can be discharged from the high-pressure pump 20, the control valve 30 is closed with as the low electrical energy as possible.

In this embodiment, attention is focused on a point that whether the high-pressure pump 20 is actuated with respect to the drive command can directly be confirmed in accordance with movement of the valve body in the case where the drive signal of the control valve 30 is switched. In view of this attention point, in this embodiment, a movement detection section for detecting the movement of the valve body with respect to the drive command of the control valve 30 and an actuation determination section for making an actuation determination of the high-pressure pump 20 on the basis of a detection result of the movement detection section are provided.

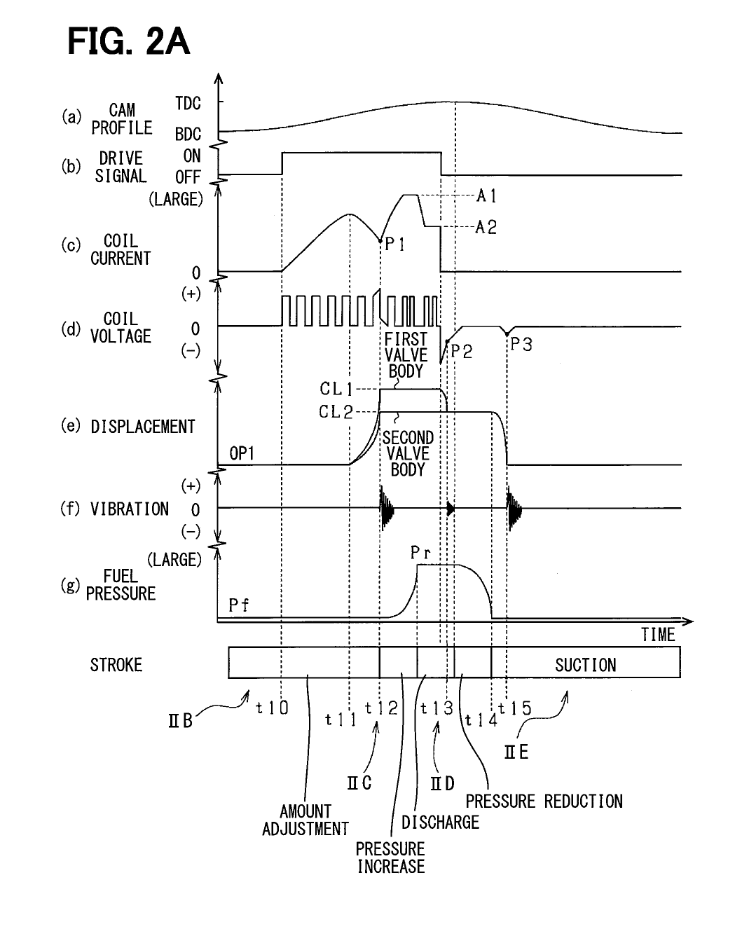

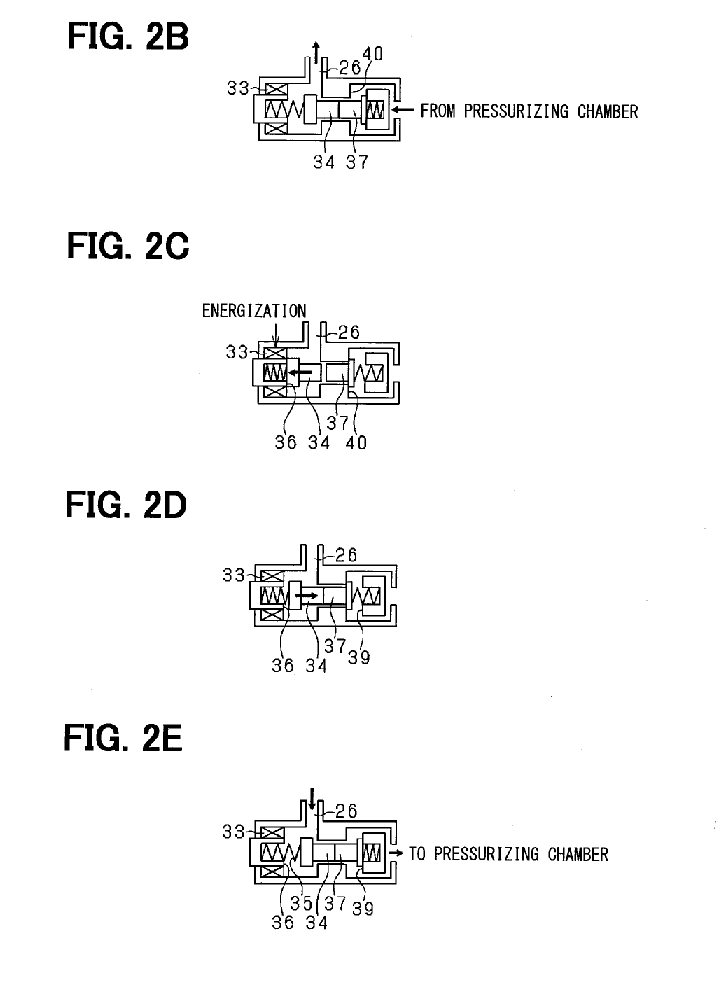

FIG. 2A is a time chart of a behavior when the high-pressure pump 20 is actuated normally with respect to the drive command by the ECU 50. In FIG. 2A, (a) indicates a relationship between a position of the plunger 22 that is associated with the rotation of the cam 23 and time, (b) indicates a relationship between a drive signal of the control valve 30 and time, (c) indicates a relationship between the output current of the coil 33 and time, (d) indicates a relationship between a coil voltage and the time, the coil voltage being a voltage between an input terminal and an output terminal of the coil 33, (e) indicates relationships between displacements of the first valve body 34 and the second valve body 37 from the valve opening positions and time, (f) indicates a relationship between a vibration that is generated in the control valve 30 (for example, the valve main body) and time, and (g) indicates a relationship between the fuel pressure in the pressurizing chamber 25 and time. The position of the plunger 22 that is associated with the rotation of the cam 23 corresponds to a profile of the cam 23. The coil voltage is also referred to as a voltage between the input/output terminals.

In (a), BDC represents bottom dead center of the plunger 22, and TDC represents top dead center of the plunger 22. Regarding the drive signal of (b), an OFF signal is outputted in a case of a valve opening command for keeping the control valve 30 to be in a valve opened state, and an ON signal is outputted in a case of a valve closing command for keeping the control valve 30 to be in a valve closed state. In (g), Pf represents feed pressure as fuel pressure in the low-pressure pipe 13, and Pr represents rail pressure as the fuel pressure in the pressure accumulator chamber 14.

In a volume increase stroke that corresponds to a period in which the plunger 22 moves in the first direction to increase the volume of the pressurizing chamber 25 in conjunction with the rotation of the cam 23, as depicted in FIG. 2E, the coil 33 is not energized, and the first valve body 34 and the second valve body 37 are set at the valve opening positions. That is, the first valve body 34 is in a state of separating from the first stopper 36 by the urging force of the first spring 35, and the second valve body 37 is in a state of abutting against the second stopper 39 by the first valve body 34. In this way, the pressurizing chamber 25 and the fuel suction passage 26 are brought into a communicating state, and the low-pressure fuel is introduced into the pressurizing chamber 25. In this embodiment, a period in which the low-pressure fuel is introduced into the pressurizing chamber 25 is a suction stroke.

In a period in which the plunger 22 moves from the bottom dead center to the top dead center, the volume of the pressurizing chamber 25 is reduced. In a volume reduction stroke that corresponds to this period, valve closing is commanded at timing that corresponds to a requested discharge amount, and the energization of the coil 33 is started. At this time, before a start of the energization of the coil 33 (before t12), the second valve body 37 is in a state of separating from the valve seat 40. Accordingly, as depicted in FIG. 2B, the fuel in the pressurizing chamber 25 is returned to the fuel suction passage 26 side along with the movement of the plunger 22. In this embodiment, a period in which the fuel in the pressurizing chamber 25 is returned to the fuel suction passage 26 side is an amount adjustment stroke.

The first valve body 34 is attracted toward the coil 33 by the start of the energization of the coil 33, and as depicted in FIG. 2C, the first valve body 34 moves to a valve closing position CL1 that is a position at which the first valve body 34 abuts against the first stopper 36. At this time, the first valve body 34 collides with the first stopper 36. In this way, the vibration is generated as depicted in (f) in FIG. 2A. Once a predetermined time elapses from the start of the energization of the coil 33, the pressurizing chamber 25 and the fuel suction passage 26 are brought into a state where the communication therebetween is blocked by the second valve body 37. In this case, the predetermined time is a valve closing required time that corresponds to a time required for the second valve body 37 to be actually seated on the valve seat 40 and brought into the valve closed state from switching to the ON signal. When the plunger 22 moves in the second direction in this state, the fuel pressure in the pressurizing chamber 25 is increased. In this embodiment, a period in which the fuel pressure in the pressurizing chamber 25 is increased is a pressure increase stroke. High-pressure fuel, pressure of which has been increased to be high, is discharged to the fuel discharge passage 27 side. In this embodiment, a period in which the high-pressure fuel is discharged to the fuel discharge passage 27 side is a discharge stroke. Accordingly, a pump discharge amount is increased by advancing energization start timing of the coil 33, and the pump discharge amount is reduced by delaying the timing.

In the pressure increase stroke, as depicted in (g) in FIG. 2A, the fuel pressure in the pressurizing chamber 25 is increased, but the pressure increase appears after the timing t12 at which movement of the first valve body 34 and the second valve body 37 to the valve closing positions are completed. In addition, a delay occurs to transmission of a pressure change of the pressurizing chamber 25 to the pressure accumulator chamber 14 due to presence of a fuel pipe. Thus, it takes time until the movement of the valve body appears as a change in the fuel pressure in the pressure accumulator chamber 14.

When the energization of the coil 33 is stopped, as depicted in FIG. 2D, the first valve body 34 separates from the first stopper 36, abuts against the second valve body 37, and is held in an abutment state for a predetermined time that corresponds to t13 to t14. In the abutment state of both, the first valve body 34 and the second valve body 37 are held at a valve closing position CL2 of the second valve body 37. At this time, due to collision of the first valve body 34 with the second valve body 37, the vibration is generated as depicted in (f) in FIG. 2A.

Thereafter, when the plunger 22 moves from the top dead center toward the bottom dead center, the volume of the inside of the pressurizing chamber 25 is increased, and the pressure in the pressurizing chamber 25 is reduced. In this embodiment, a period in which the pressure in the pressurizing chamber 25 is reduced is a pressure reduction stroke. In this way, at t14 onward, fuel pressure in the second valve chamber 32 is reduced. Thus, the first valve body 34 and the second valve body 37 are permitted to move and each move to the valve opening position. At timing t15, the second valve body 37 collides with the second stopper 39 when being pressed by the first valve body 34 in the axial direction, and the vibration is thereby generated as depicted in (f) in FIG. 2A.

Regarding the energization control of the coil 33, in this embodiment, immediately after the start of the energization of the coil 33, variable control (PWM drive) of a duty ratio of the voltage that is applied to the coil 33 is executed such that the current flowing through the coil 33 is increased to a first current value A1 as a valve closing current. When the coil current is increased to the first current value A1, the control is shifted to constant current control. More specifically, first constant current control for controlling the coil current at the first current value A1 is first executed for a predetermined time. Next, the control is shifted to second constant current control for controlling the coil current at a second current value A2 that is a lower holding current than the first current value.

In the case where the first valve body 34 and the second valve body 37 move in conjunction with the energization of the coil 33, the movement thereof appears as a change in a current that flows through the coil 33. More specifically, due to a coil characteristic, as the first valve body 34 approaches the coil 33, inductance of the coil 33 is increased, and the current flowing through the coil 33 is gradually reduced. Thus, in a state where a predetermined voltage is applied from the power supply 53 to the coil 33 by the duty control, as depicted in (c) in FIG. 2A, the coil current is increased over time until the first valve body 34 starts moving. When the first valve body 34 starts moving from a valve opening position OP1 (t11), the coil current is gradually reduced as the first valve body 34 approaches the valve closing position CL1 (an abutment position against the first stopper 36). When the first valve body 34 abuts against the first stopper 36 and thereby stops moving, the inductance is stabilized again, and the coil current is increased again. That is, in the case where the first valve body 34 moves in conjunction with the energization of the coil 33, as depicted in (c) in FIG. 2A, in an ON period of the drive signal, the coil current is switched from an increased tendency to a reduced tendency and is thereafter shifted from the reduced tendency to an increase. In this way, a bending point P1 appears to the coil current in the ON period of the drive signal.

In the system, immediately after switching from ON to OFF of the drive signal, the voltage in a reverse direction is applied to the coil 33. In this way, flyback for accelerating a reduction speed of the current that flows through the coil 33 is executed. Accordingly, as depicted in FIG. 2A, when the drive signal is switched from ON to OFF, the coil current immediately becomes 0. Meanwhile, the voltage between the input/output terminals of the coil 33 is significantly changed in a reverse direction in conjunction with the switching of the drive signal from ON to OFF, is then shifted to a gradual increase, and is eventually converged to 0. In addition, in the system, an upper guard value is provided to the current that flows through the coil 33. As the upper guard value, A1 is set for a predetermined time from the energization start timing, and A2 is set after a lapse of the predetermined time. In this embodiment, A1 is larger than A2.

In the case where the first valve body 34 and the second valve body 37 move in conjunction with the energization of the coil 33, the movement thereof appears as a change in a voltage that is applied to the coil 33. In this embodiment, the voltage that is applied to the coil 33 is the voltage between the input/output terminals of the coil 33. More specifically, in the ON period of the drive signal, as depicted in (d) in FIG. 2A, in conjunction with a change in the inductance of the coil 33 that is caused by approaching of the first valve body 34 to the coil 33, the voltage is changed by a predetermined value or more near the timing t12, and the change is apart from a voltage change by the duty control.

In addition, after the switching from ON to OFF of the drive signal, the voltage between the input/output terminals of the coil 33 is significantly changed in the reverse direction by the flyback, is then shifted to the increase, and is converged to 0. In a period in which the voltage is reduced toward zero, a change amount of the voltage per unit time is reduced, and a bending point P2 appears. That is, the inductance of the coil 33 is reduced as the first valve body 34 separates from the coil 33 by the timing 13 at which the first valve body 34 abuts against the second valve body 37, and the inductance becomes constant when the movement of the first valve body 34 is stopped. The change in the inductance appears as the voltage change.

Furthermore, in a period after the voltage is converged to zero, the inductance of the coil 33 is changed by displacement of the first valve body 34 from the abutment position CL2 that is associated with a reduction in the pressure of the second valve chamber 32. In conjunction with this, the voltage between the input/output terminals of the coil 33 is changed. This change appears as a bending point P3.

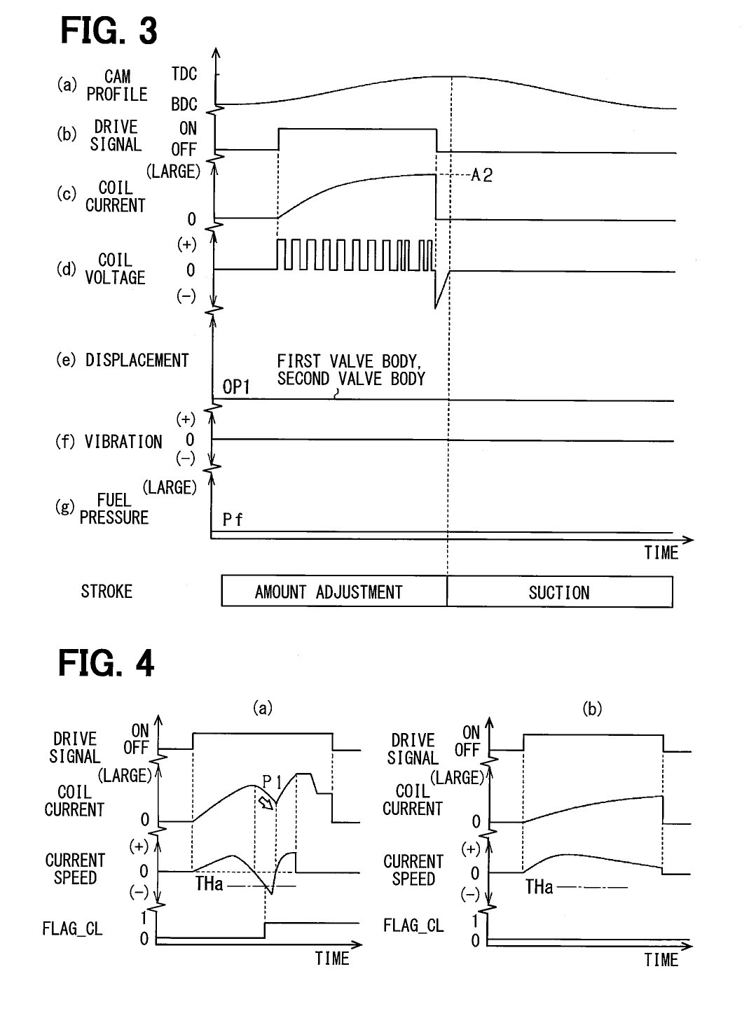

On the other hand, in the case where the first valve body 34 is not displaced from the valve opening position regardless of a fact that the drive signal for switching the control valve 30 to the valve closing is outputted, a state in FIG. 2B is retained after the output of the drive signal. In such a case, as depicted in FIG. 3, even when the drive signal is switched between ON/OFF, behaviors that are observed when the first valve body 34 and the second valve body 37 show the normal movement, more specifically, a change in the coil current and the change in the voltage in the ON period of the drive signal as well as the change in the voltage after switching of the drive signal from ON to OFF are not observed. From the above, according to a configuration for detecting the movement of the valve body with respect to the drive command, it is apparent that whether to permit the actuation of the high-pressure pump 20 can be determined. The current change and the voltage change as described above appear when the valve closing required time of the first valve body 34 is extended and the first valve body 34 thereby moves to the valve closing position before the coil current reaches the first current value A1.

In this embodiment, attention is focused on that the movement of the first valve body 34 with respect to the drive command of the valve closing of the control valve 30 appears in a synchronous manner with the movement of the first valve body 34 as the change in the current flowing through the coil 33. By indirectly detecting the movement of the first valve body 34 on the basis of the change in the coil current, whether to permit the actuation of the high-pressure pump 20 is determined. More specifically, as the change in the current with respect to the drive command, switching of the coil current between the increased tendency and the reduced tendency is detected. When the switching of the coil current from the increased tendency to the reduced tendency is detected, such a determination that the high-pressure pump 20 is actuated is made.

FIG. 4 includes time charts of specific aspects of a pump actuation determination of this embodiment. In this embodiment, occurrence of the reduced tendency of the coil current in the ON period of the drive signal is detected on the basis of a current speed that corresponds to a differential value of the current (a differential value of the current), and the pump actuation determination is made on the basis of a detection result. That is, when the first valve body 34 moves to the valve closing position, as depicted in FIG. 4(a), the reduced tendency of a coil current value occurs in the ON period of the drive signal, and the current speed shows a negative value. On the other hand, when the movement of the first valve body 34 is not observed in conjunction with the drive command of the valve closing of the control valve 30, as depicted in FIG. 4(b), the current speed does not show the negative value in the ON period of the drive signal. In this embodiment, the current speed and a determination value THa are compared by using this, and whether to permit the actuation of the high-pressure pump 20 is determined on the basis of a comparison result. In this embodiment, the determination value THa is smaller than zero.

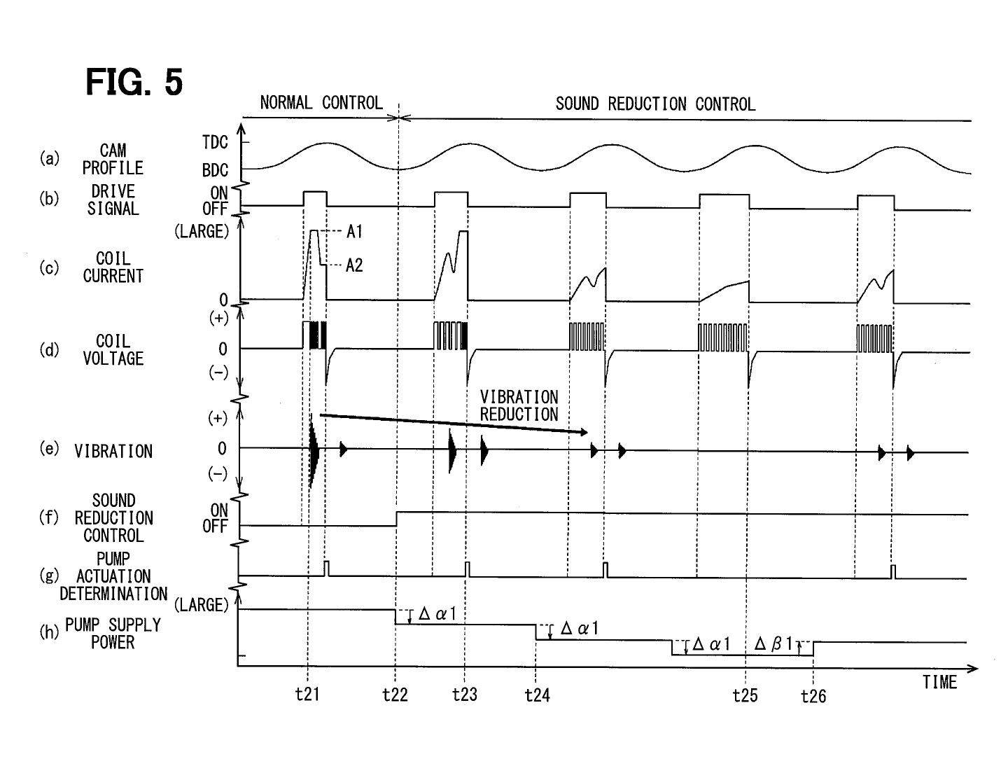

Next, an overview of the sound reduction control of the high-pressure pump 20 will be described by using FIG. 5. In FIG. 5, (a) indicates a relationship between a position of the plunger 22 and time, (b) indicates a relationship between the drive signal of the control valve 30 and time, (c) indicates a relationship between the coil current and time, (d) indicates a relationship between the voltage between the input/output terminals of the coil 33 and time, (e) indicates a relationship between a vibration generated in the control valve 30 (the valve main body) and time, (f) indicates whether to permit execution of the sound reduction control, (g) indicates a determination result of the pump actuation determination, and (h) indicates a relationship between the pump supply power and time.

In a period before timing t22 in which normal control is executed in the discharge amount control of the high-pressure pump 20, 100% is set, for example, as the duty ratio of the voltage applied to the coil 33. In this way, as depicted in FIG. 5, the coil current is rapidly increased to the first current value A1 in conjunction with switching of the drive signal to ON. In addition, the first valve body 34 moves to the valve closing position and collides with the first stopper 36 by a start of coil energization. Accordingly, the vibration is generated in the control valve 30 at timing t21. The normal control of the pump discharge amount control is executed in the engine operation state during the travel of the vehicle, for example.

When the engine is shifted to the idle operation state at the timing t22, the discharge amount control of the high-pressure pump 20 is switched from the normal control to the sound reduction control. In the sound reduction control, a displacement speed of the first valve body 34 is reduced by causing the duty ratio of the coil application voltage in the PWM drive to be lower than the duty ratio in the normal control. More specifically, when it is determined at timing t23 that the high-pressure pump 20 is actuated in the last energization of the coil 33, the power reduction control for reducing the pump supply power in the current energization by a predetermined amount Δα1 from the pump supply power in the last energization is executed at timing t24. The last energization corresponds to “prior energization”, and the current energization corresponds to “later energization”.

When it is detected at timing t25 that the high-pressure pump 20 is not actuated in the last energization, the power increase control for increasing the pump supply power in the current energization by a predetermined amount Δβ1 from the pump supply power in the last energization is executed at timing t26. By alternately repeating the power reduction control and the power increase control, the coil is energized with minimum power (actuation limit power) with which the first valve body 34 can move to the valve closing position. In this way, the first valve body 34 moves as slow as possible within a range where the control valve 30 can be closed, the vibration during the collision against the first stopper 36 is reduced, and, in this way, the actuation sound during the collision is reduced.

In this embodiment, the change amount Δα1 of the pump supply power by the power reduction control and the change amount Δβ1 of the pump supply power by the power increase control are set to be the same. Thus, in the case where the actuation of the high-pressure pump 20 in the last energization is detected, the pump supply power is reduced by Δα1, and the high-pressure pump 20 is not actuated with the supply power, the high-pressure pump 20 is again brought into the actuated state by increasing the pump supply power by Δβ1.

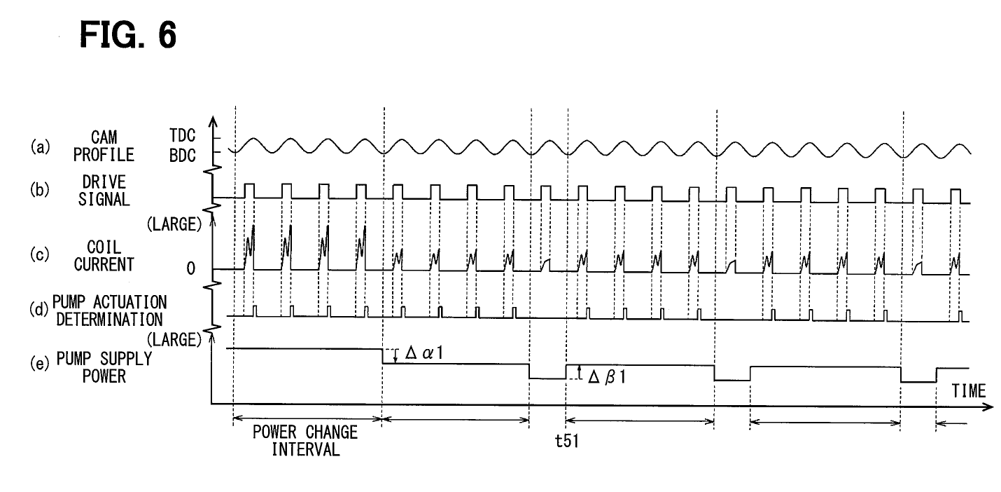

In the sound reduction control of this embodiment, the pump supply power is changed with a case where the pump actuation state is detected for predetermined multiple times by the above pump actuation determination process as one interval. More specifically, as depicted in FIG. 6, a period after time at which it is determined that the high-pressure pump 20 is not actuated until it is detected that the high-pressure pump 20 is continuously actuated for the multiple times is set as one interval. When a next power change interval arrives, the pump supply power is reduced or increased by a predetermined amount. In this embodiment, a period until it is detected that the high-pressure pump 20 is continuously actuated for 4 times is set as a power change interval.

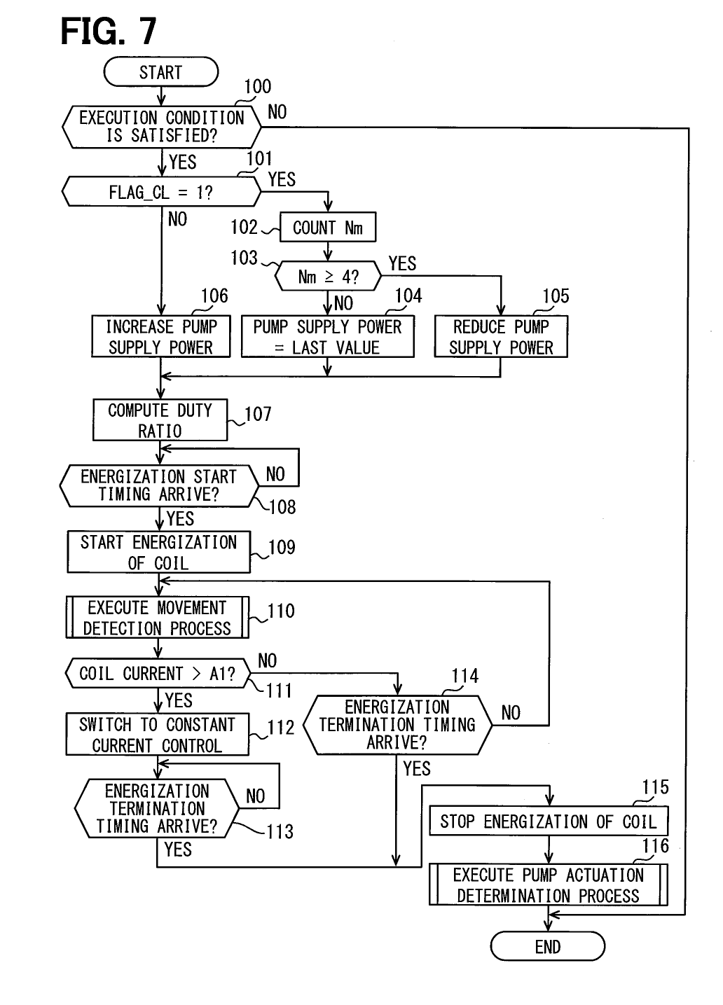

Next, the sound reduction control of the high-pressure pump 20 of this embodiment will be described by using flowcharts in FIG. 7 to FIG. 9. The process is executed by the microcomputer of the ECU 50 at predetermined intervals.

In FIG. 7, the microcomputer determines in 100 whether an execution condition of the sound reduction control is satisfied. The execution control of the sound reduction control includes, for example, being the idle operation state and the like. When the microcomputer makes a positive determination in 100, advances the process to 101, and determines whether the high-pressure pump 20 is actuated in the last energization. A determination of whether the high-pressure pump 20 is actuated in the last energization is made by the microcomputer on the basis of a process result of the pump actuation determination process. When a valve closing determination flag FLAG_CL is set to 1 in the last energization, the microcomputer determines that the pump is actuated. When the valve closing determination flag FLAG_CL is set to 0, the microcomputer determines that the pump is not actuated.

When the microcomputer makes a positive determination in 101, advances the process to 102, and counts command number Nm for the continuous determination of the actuation of the high-pressure pump 20 in a period including the last energization. In other words, the microcomputer adds 1 to the command number Nm. In 103, the microcomputer determines whether the counted number Nm is at least equal to predetermined number. In this embodiment, the predetermined number is 4. When the number Nm is lower than the predetermined number, the process proceeds to 104, and the microcomputer sets a last value as the pump supply power in the current energization. When the number Nm is at least equal to the predetermined number, the process proceeds to 105, and the microcomputer sets a value that is obtained by subtracting Δα1 from the last value as the pump supply power in the current energization.

On the other hand, when the microcomputer determines that the high-pressure pump 20 is not actuated in the last energization, a negative determination is made in 101, and the process proceeds to 106. In 106, the microcomputer sets a value that is obtained by increasing the last value by Δβ1 as the pump supply power in the current energization. In this embodiment, the processes in 101 to 106 correspond to the energization control section.

When the microcomputer sets the pump supply power in the current energization, the duty ratio of the voltage in the PWM drive that corresponds to the set pump supply power is computed in 107. The microcomputer determines in 108 whether the energization start timing for energizing the coil 33 arrives. When it is time before the energization start timing arrives, the microcomputer is suspended as is. When it is the energization start timing, the process proceeds to 109, and the microcomputer starts energizing the coil at the computed duty ratio.

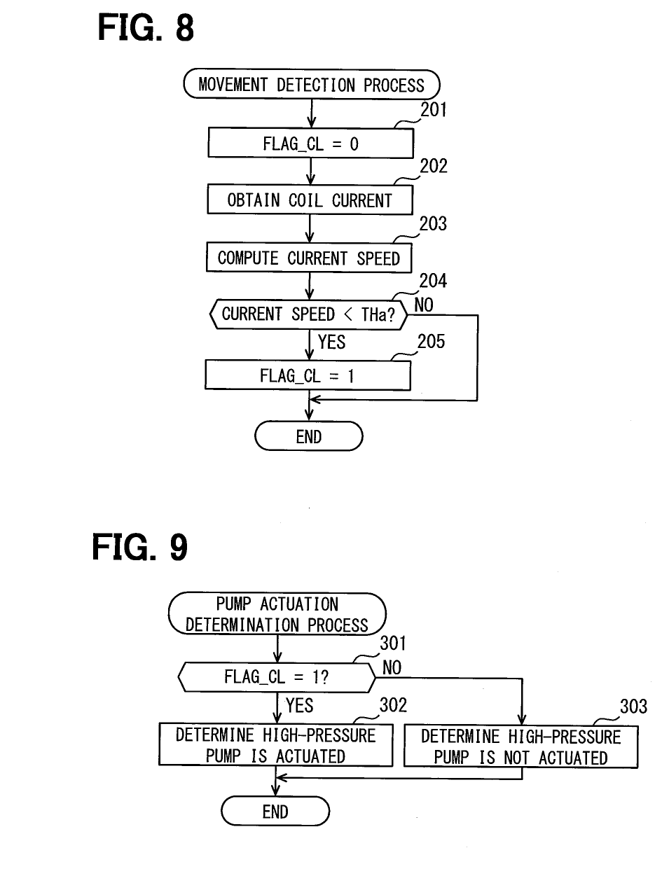

In 110, the microcomputer executes a movement detection process depicted in FIG. 8. In 201 in FIG. 8, the microcomputer resets the valve closing determination flag FLAG_CL to 0. The valve closing determination flag FLAG_CL is a flag for indicating that the control valve 30 is brought into the valve closed state by the drive command. When the microcomputer determines that the control valve 30 is brought into the valve closed state, the valve closing determination flag FLAG_CL is set to 1.

In 202, the microcomputer obtains the coil current value that is detected by the current sensor 54. In 203, the microcomputer computes the current speed that corresponds to a speed of the pump current. In 204, the microcomputer determines whether the computed current speed is lower than the determination value THa. When the microcomputer makes a positive determination, the process proceeds to 205, and the valve closing determination flag FLAG_CL is set to 1. In this embodiment, the processes in 110, 201 to 205 correspond to the movement detection section.

In 111, the microcomputer determines whether the coil current detected by the current sensor 54 exceeds the first current value A1. When the microcomputer makes a positive determination in 111, the process proceeds to 112, and the PWM drive is switched to the constant current control. In the constant current control, the microcomputer first executes the first constant current control for controlling the coil current at the first current value A1. After a predetermined time elapses from a start of the execution of the first constant current control, the second constant current control for controlling the coil current at the second current value A2 is then executed.

During the execution of the constant current control, the microcomputer determines in 113 whether energization termination timing for terminating the energization of the coil 33 arrives. When the energization termination timing arrives, the process proceeds to 115, and the microcomputer outputs the valve opening command of the control valve 30. In this way, the energization of the coil 33 from the power supply 53 is stopped.

When the microcomputer makes a negative determination in 111, the process proceeds to 114, and it is determined whether the energization termination timing arrives. When the energization termination timing arrives, the microcomputer advances the process to 115. When it is before the energization termination timing, the microcomputer executes the movement detection process in 110 again.

In 116, the microcomputer executes the pump actuation determination process depicted in FIG. 9. In FIG. 9, in 301, the microcomputer loads the valve closing determination flag FLAG_CL and determines whether FLAG_CL is 1. When it is determined that FLAG_CL is 1, the process proceeds to 302, and the microcomputer determines that the high-pressure pump 20 is actuated normally by the drive command. When it is determined that FLAG_CL is 0, the process proceeds to 303, and the microcomputer determines that the high-pressure pump 20 is not actuated with respect to the drive command. In this embodiment, the processes in 116, 301 to 303 correspond to the actuation determination section. Then, the microcomputer terminates this routine.

The fuel discharge amount of the high-pressure pump 20 is controlled by energization start timing TIME_ON of the control valve 30 and is specifically expressed by a following equation (1).

TIME_ON=TIME_Q+TIME_P+TIME_F/B+TIME_CL (1)

In the equation (1), TIME_Q represents a discharge time that corresponds to a time required to discharge the fuel in the pressurizing chamber 25, TIME_P represents a pressure increase time that corresponds to a time required to increase the pressure of the fuel in the pressurizing chamber 25, TIME_F/B represents a fuel pressure feedback correction amount, and TIME_CL represents the valve closing required time.

The discharge time TIME_Q is computed on the basis of the requested discharge amount of the high-pressure pump 20, and a longer time is set therefor as the requested discharge amount is increased. The pressure increase time TIME_P is computed on the basis of the target fuel pressure, and a longer time is set therefor as the target fuel pressure is increased. The fuel pressure feedback correction amount TIME_F/B is computed on the basis of a deviation of the actual fuel pressure in the pressure accumulator chamber 14 from the target fuel pressure, and a larger value is set therefor as the deviation is increased.

The valve closing required time TIME_CL is a time required for the second valve body 37 to move to the valve closing position from the energization start timing (valve closing command timing). In this embodiment, a displacement speed of the first valve body 34 is reduced by limiting the pump supply power during the execution of the sound reduction control. In this way, the valve closing required time TIME_CL is extended for a long period. Accordingly, in the case where the energization start timing TIME_ON is computed with the valve closing required time as a predetermined constant value, a fuel discharge period cannot sufficiently be secured due to extension of the valve closing required time. Thus, a desired fuel amount cannot possibly be discharged from the high-pressure pump 20.

In view of the above, in this embodiment, the microcomputer computes the valve closing required time TIME_CL on the basis of the pump supply power, and computes the energization start timing TIME_ON on the basis of the computed valve closing required time TIME_CL.

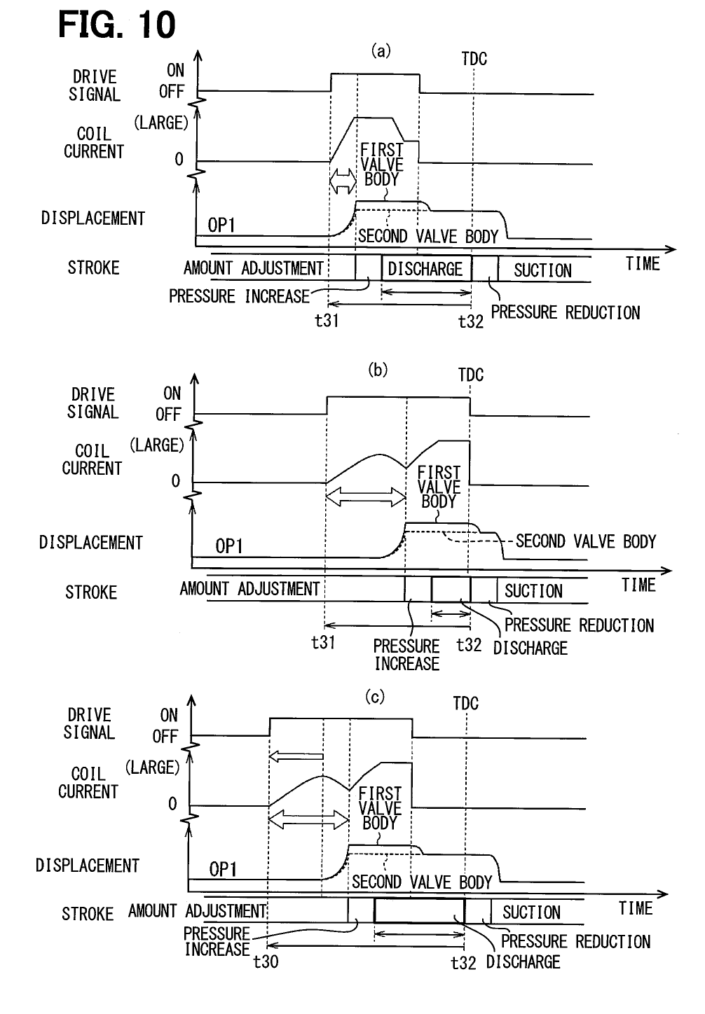

FIG. 10 depicts relationships among the valve closing required time, the discharge period, and the energization start timing. In the drawing, (a) indicates a time in which the normal control is executed, (b) indicates a case where the energization start timing is aligned with the normal control in a time in which the sound reduction control is executed, and (c) indicates a case where the energization start timing is computed from the valve closing required time that corresponds to the pump supply power in the sound reduction control.

In the sound reduction control, in the case where the energization start timing is set to timing t31 that is the same as the normal control, as depicted in FIG. 10(b), there is a case where discharge of the fuel is terminated in the middle at a time point t32 at which the plunger 22 reaches a top dead center (TDC). In such a case, the discharge period of the fuel is shortened, and a desired amount of the fuel is not discharged. On the contrary, in the case where the energization start timing TIME_ON is computed on the basis of the valve closing required time TIME_CL that corresponds to the pump supply power, as depicted in FIG. 10(c), the discharge period can sufficiently be secured, and thus the desired amount of the fuel can be discharged from the high-pressure pump 20.

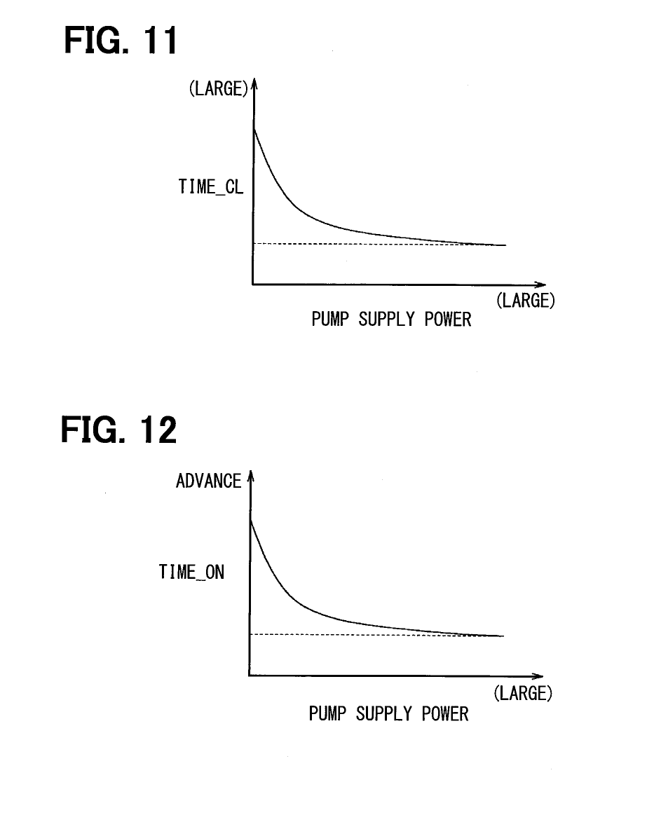

FIG. 11 depicts a relationship between the pump supply power and the valve closing required time TIME_CL. FIG. 12 depicts a relationship between the pump supply power and the energization start timing TIME_ON. As depicted in FIG. 11, the valve closing required time TIME_CL is extended as the pump supply power is reduced. Accordingly, in this embodiment, as depicted in FIG. 12, the energization start timing is set to an advanced side as the pump supply power is reduced.

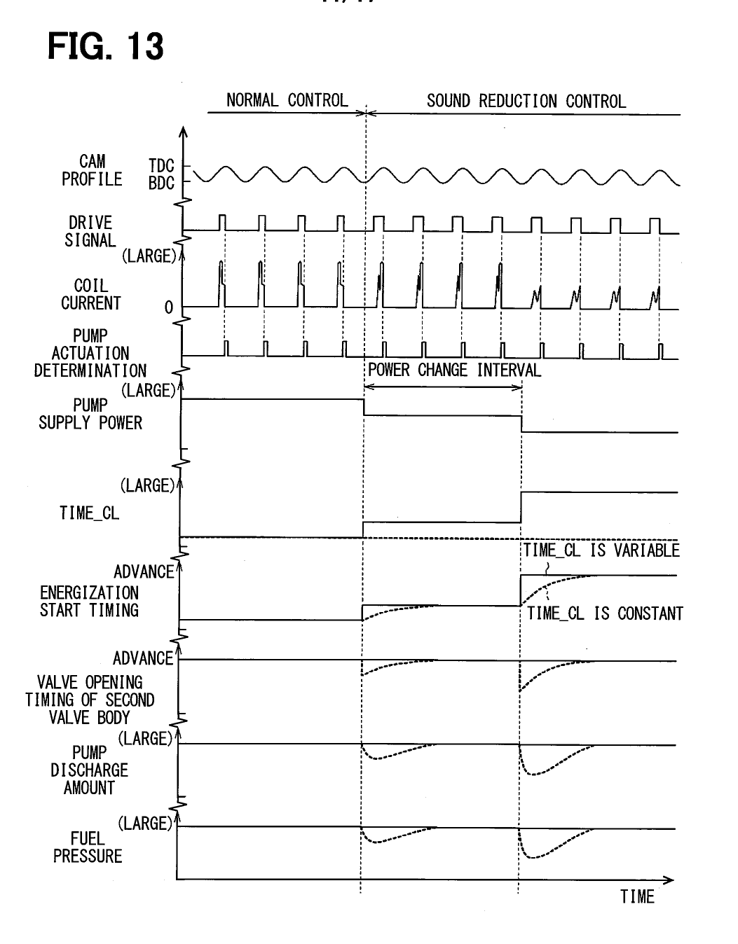

FIG. 13 is a time chart for representing a difference between a case where the valve closing required time TIME_CL is set to be variable in accordance with the pump supply power and a case where the valve closing required time TIME_CL is set as a constant value. A solid line indicates that the valve closing required time TIME_CL is set to be variable, and a broken line indicates that the valve closing required time TIME_CL is set as the constant value. In FIG. 13, the engine operation state in the case where the requested discharge amount and the target fuel pressure of the high-pressure pump 20 are constant is assumed.

In FIG. 13, in the case where the valve closing required time TIME_CL is set as the constant value, as indicated by the broken line, the valve closing timing of the first valve body 34 is deviated to a delayed side, and thus the valve closing timing of the second valve body 37 is deviated to a delayed side. In addition, because the discharge period is shortened, the fuel discharge amount of the high-pressure pump 20 is reduced, and due to this, the fuel pressure in the pressure accumulator chamber 14 is temporarily reduced. Even in the case where the valve closing required time TIME_CL is set as the constant value, after the fuel pressure is temporarily reduced, the fuel pressure is recovered by a lapse of a predetermined time due to correction of the energization start timing by fuel pressure feedback control. However, a long time is required for the recovery.

On the other hand, in the case where the valve closing required time TIME_CL is set to be variable in accordance with the pump supply power, as indicated by the solid line in FIG. 13, the energization start timing is changed to the advanced side in accordance with the pump supply power. In this way, the fuel discharge amount of the high-pressure pump 20 is retained as the requested discharge amount, and the fuel pressure in the pressure accumulator chamber 14 is retained at the target fuel pressure.

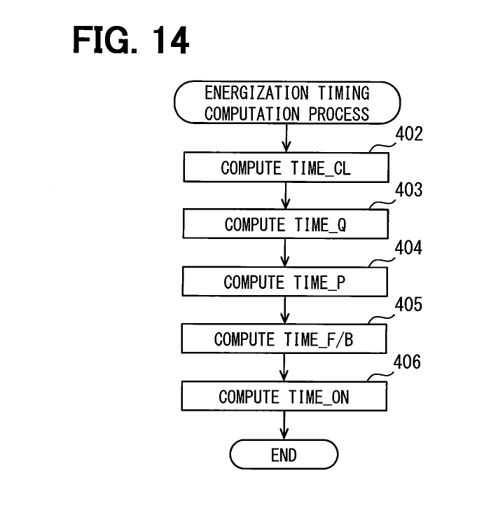

Next, an energization timing computation process for computing the energization start timing of the high-pressure pump 20 will be described by using FIG. 14. The energization timing computation process is executed by the microcomputer of the ECU 50 at timing at which the pump supply power in the current energization is computed.

In FIG. 14, the microcomputer computes the valve closing required time TIME_CL on the basis of the computed pump supply power in 402. In this embodiment, the relationship between the pump supply power and the valve closing required time TIME_CL is defined in a table or a map in advance, and the valve closing required time TIME_CL that corresponds to the pump supply power in the current energization is computed by using this. In this embodiment, the process in 402 corresponds to a time computation section.

It should be noted that the time computation section is not limited to the above. The valve closing required time TIME_CL that corresponds to the pump supply power in the current energization may be computed by defining and storing an initial value of the valve closing required time TIME_CL in advance and correcting the initial value on the basis of the pump supply power. In this case, for example, a correction coefficient that corresponds to the pump supply power is defined in advance, and the valve closing required time TIME_CL is computed by using the correction coefficient that corresponds to the pump supply power in the current energization. At this time, as the correction coefficient, a larger value may be set as the pump supply power is reduced. In this embodiment, the correction coefficient is larger than zero.

In 403, the microcomputer computes the requested discharge amount of the high-pressure pump 20 on the basis of the fuel injection amount of the injector 15 and also computes the discharge time TIME_Q on the basis of the computed requested discharge amount. In 404, the microcomputer computes the target fuel pressure that is a target value of the fuel pressure in the pressure accumulator chamber 14, and also computes the pressure increase time TIME_P on the basis of the target fuel pressure. In 405, the microcomputer computes a fuel pressure F/B correction amount TIME_F/B on the basis of the deviation of the actual fuel pressure detected by the fuel pressure sensor 52 from the target fuel pressure. In 406, the microcomputer computes the energization start timing TIME_ON on the basis of the above equation (1) by using a computed value of each of the valve closing required time TIME_CL, the discharge time TIME_Q, the pressure increase time TIME_P, and the fuel pressure F/B correction amount TIME_F/B. In this embodiment, the process in 406 corresponds to the timing computation section. Then, the microcomputer terminates this routine.

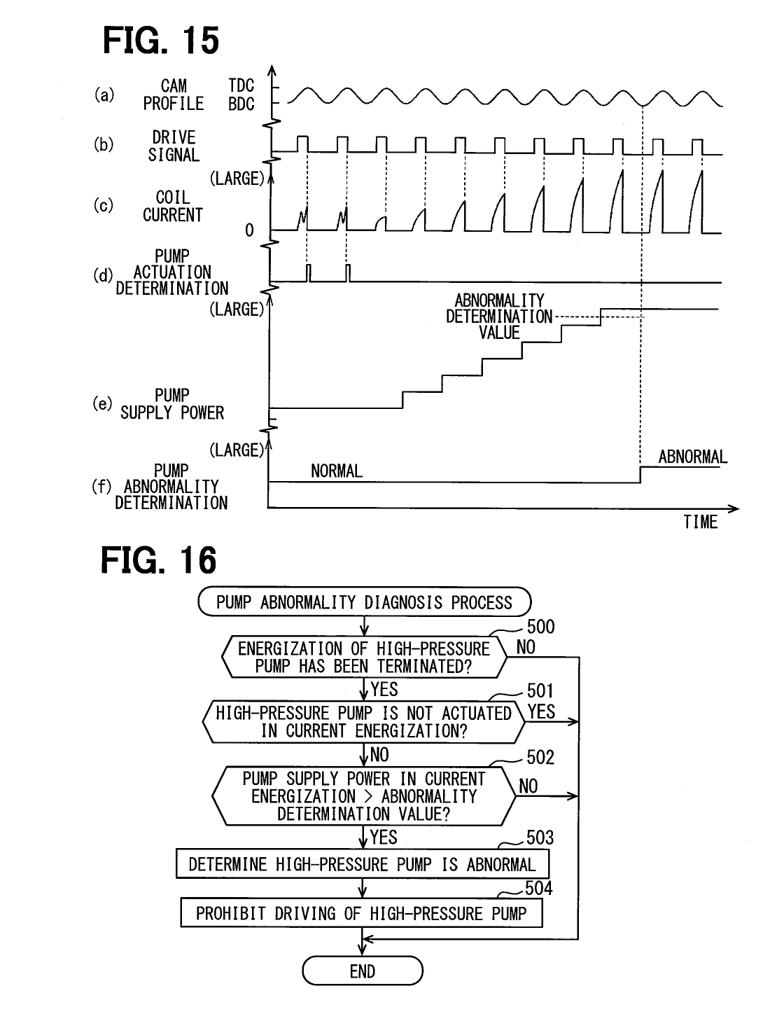

Next, an abnormality diagnosis process of the high-pressure pump 20 will be described. In this embodiment, in the case where it is determined that the high-pressure pump 20 is not actuated in the last energization by the pump actuation determination process, the pump supply power is changed to an increase side. However, as depicted in FIG. 15, in the case where a state where it is determined that the high-pressure pump 20 is not actuated by the pump actuation determination process continues and where the pump supply power is excessively increased, it is assumed that actuation abnormality of the high-pressure pump 20 occurs. Thus, in this embodiment, in the case where the pump supply power exceeds an abnormality determination value during the execution of the sound reduction control, it is determined that the actuation abnormality of the high-pressure pump 20 occurs.

FIG. 16 is a flowchart of a process procedure of the pump abnormality diagnosis process. This pump abnormality diagnosis process is executed by the microcomputer of the ECU 50 at predetermined intervals during the execution of the sound reduction control.

In FIG. 16, the microcomputer determines in 500 whether the energization of the high-pressure pump 20 has been terminated. When the microcomputer makes a positive determination in 500, advances the process to 501, and determines whether it is determined that the high-pressure pump 20 is not actuated in the current energization. When the microcomputer determines that the high-pressure pump 20 is actuated, this routine is terminated as is. When the microcomputer determines that the pump is not actuated, advances the process to 502, and determines whether the pump supply power in the current energization exceeds the abnormality determination value.

When the pump supply power in the current energization is at most equal to the abnormality determination value, the microcomputer terminates this routine as is. When the pump supply power in the current energization exceeds the abnormality determination value, the process proceeds to 503, and the microcomputer determines that the high-pressure pump 20 is abnormal. In 504, the microcomputer prohibits driving of the high-pressure pump 20. Then, the microcomputer terminates this routine.

According to this embodiment that has been described in detail so far, following superior effects are obtained.

The actuation state of the high-pressure pump 20 is determined by monitoring the movement of the first valve body 34 with respect to the drive command of the control valve 30, and the pump supply power is controlled on the basis of the result of the pump actuation determination. When the first valve body 34 shows the normal movement with respect to the drive command of the control valve 30, the high-pressure pump 20 is immediately actuated in conjunction with the movement of the first valve body 34, and the fuel is discharged from the high-pressure pump 20. On the other hand, when the first valve body 34 does not show the normal movement with respect to the drive command, the high-pressure pump 20 is not actuated, and the fuel is not discharged from the high-pressure pump 20. Thus, according to a configuration for determining the actuation state of the high-pressure pump 20 by monitoring the movement of the first valve body 34 with respect to the drive command of the control valve 30, whether the high-pressure pump 20 is actuated or not actuated with respect to the drive command can accurately be detected. In addition, because the actuation/non-actuation of the high-pressure pump 20 with respect to the drive command can accurately be detected, the supply power to the electromagnetic section can be controlled with as low power as possible within a range where the high-pressure pump 20 can be actuated. Thus, according to the above configuration, the noise that is generated during the actuation of the high-pressure pump 20 can be suppressed to be as low as possible while the actuation thereof is maintained.

More specifically, regarding the sound reduction control, in the case where it is determined that the high-pressure pump 20 is actuated in the last energization by the pump actuation determination process, in the current energization, the power reduction control for controlling the pump supply power with the power that is reduced by the predetermined amount Δα1 from the pump supply power in the last energization is executed. In the case where the actuation of the high-pressure pump 20 is detected, the high-pressure pump 20 is actuated with the further lower power than the pump supply power at the time. In this way, the actuation sound of the high-pressure pump 20 can be reduced to be as low as possible.

In the case where it is determined that the high-pressure pump 20 is not actuated in the last energization by the pump actuation determination process, in the current energization, the power increase control for controlling the pump supply power with the power that is increased by the predetermined amount Δβ1 from the pump supply power in the last energization is executed. In the case where it is detected that the high-pressure pump 20 is not actuated, the high-pressure pump 20 is actuated with the higher power than the pump supply power at the time. In this way, the high-pressure pump 20 can reliably be actuated.

In this embodiment, the power reduction control is executed as the sound reduction control. In addition, in the case where it is determined by the power reduction control that the high-pressure pump is not actuated, the power increase control is executed next. According to this configuration, as low power as possible that falls within the range where the high-pressure pump 20 can be actuated can be detected regardless of the fuel discharge amount of the high-pressure pump 20. Thus, the sound can preferably be reduced.

With the period after it is determined that the high-pressure pump 20 is not actuated until the actuation of the high-pressure pump 20 is detected for the multiple times as the one interval, the pump supply power is increased or reduced. When the pump supply power is frequently changed (for example, every drive command), the number of occurrence of the non-actuation of the pump is increased, and intermittent sound that is resulted from the non-actuation of the pump is frequently generated. In consideration of this point, by adopting the above configuration, the generation of the intermittent sound that is resulted from the non-actuation of the pump can be suppressed.

In the case where the pump supply power is limited by the sound reduction control, the valve closing required time TIME_CL is extended, and the discharge period of the fuel cannot possibly be secured sufficiently. In view of the above, the valve closing required time TIME_CL is computed on the basis of the pump supply power, and the energization start timing of the coil 33 is computed on the basis of the computed valve closing required time TIME_CL. According to this configuration, the energization can be conducted at the timing that corresponds to the valve closing required time TIME_CL. Thus, degraded controllability of the fuel pressure control that is resulted from the extension of the valve closing required time TIME_CL can be avoided.

In the case where the pump supply power exceeds the abnormality determination value during the execution of the sound reduction control, it is determined that the actuation abnormality of the high-pressure pump 20 occurs. In the case where the state where it is determined that the high-pressure pump 20 is not actuated by the pump actuation determination process continues and where the pump supply power is excessively increased, it can be determined that the actuation abnormality of the high-pressure pump 20 occurs. Thus, the actuation abnormality of the high-pressure pump 20 can precisely be comprehended.

The movement of the valve body with respect to the drive command of the valve opening or the valve closing of the control valve 30 is monitored, and the actuation state of the high-pressure pump 20 is determined from the movement of the valve body. Thus, whether to permit the actuation of the high-pressure pump 20 can accurately be comprehended.

The movement of the valve body with respect to the drive command of the valve opening or the valve closing of the control valve 30 is detected by detecting the change in the current flowing through the coil 33. Accordingly, the current sensor 54 for detecting the current flowing through the coil 33 only needs to be provided, and thus this embodiment can be realized by a low-cost and relatively simple configuration. In addition, a switching between the increased tendency and the reduced tendency of the current, which occurs when the high-pressure pump 20 is in the actuated state, appears clearly. Thus, detection accuracy is also favorable.

### Second Embodiment

Next, a second embodiment will be described. In the above first embodiment, in the case where it is determined that the high-pressure pump 20 is in the actuated state in the last energization, the power reduction control for reducing the pump supply power in the current energization by the predetermined amount from the pump supply power in the last energization, and in the case where it is determined that the high-pressure pump 20 is not actuated in the last energization, the power increase control for increasing the pump supply power in the current energization by the predetermined amount from the pump supply power in the last energization is executed. On the other hand, in this embodiment, the power reduction control and the power increase control are executed, and the actuation limit power as the minimum power, with which the first valve body 34 can move to the valve closing position, is learned. Hereinafter, a description will be centered on differences from the above first embodiment.

Learning control of the actuation limit power will be described in detail. In the learning control of this embodiment, in the case where the determination results of the pump actuation determination process differ between the last energization and the current energization, the pump supply power during the energization, during which it is determined that a high-pressure pump 20 is actuated, is obtained as a learning value of the actuation limit power of the high-pressure pump 20, and an obtained value is stored. In the sound reduction control after learning, a lower limit of the pump supply power is limited with the learning value as a lower limit guard. That is, in the case where the pump supply power in the current energization that is computed on the basis of the pump supply power in the last energization is lower than the learning value, the pump supply power is not reduced in the current energization, and the pump supply power in the last energization is maintained.

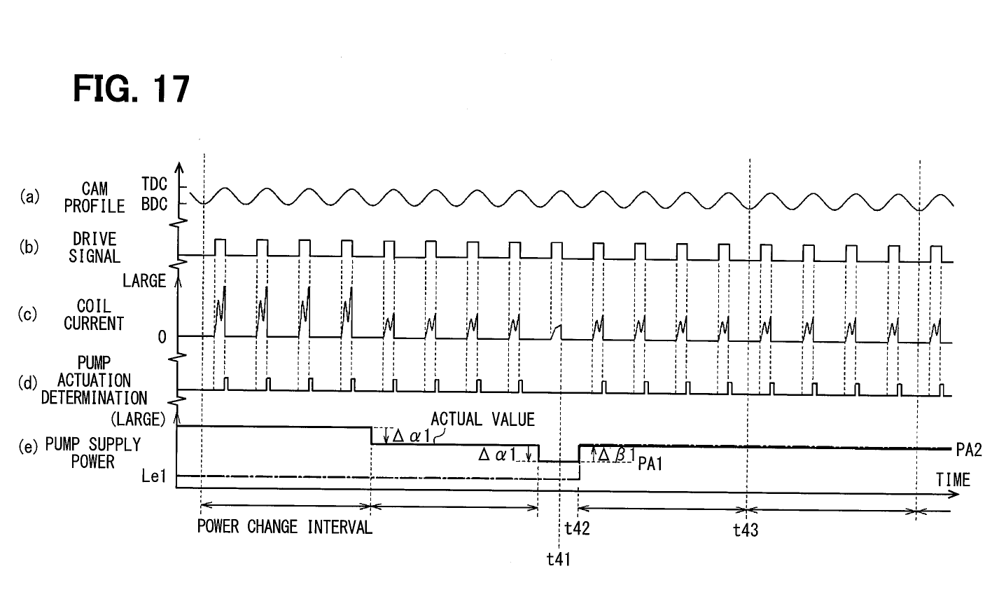

In FIG. 17, a specific aspect of the learning control of this embodiment is depicted in a time chart. In the chart, (a) indicates a relationship between the position of a plunger 22 and time, (b) indicates a relationship between a drive signal of a control valve 30 and time, (c) indicates a relationship between a coil current and time, (d) indicates a result of the actuation determination of the high-pressure pump 20, and (e) indicates a relationship between the pump supply power and time. In addition, in (e), a solid line indicates a relationship between an actual value of the pump supply power and time, and a one-dot chain line indicates a relationship between a set value of the actuation limit power and time. In FIG. 17, an initial value Le1 that is set in advance as the actuation limit power is stored in a storage section of an ECU 50 at timing t42 or earlier.

In FIG. 17, in the case where the pump supply power is reduced by Δα1 at the predetermined power change intervals by the power reduction control and it is determined that the pump is not actuated when the pump supply power is reduced to PA1 (t41), in conjunction with the determination at the timing t41 that the pump is not actuated, at timing t42, the pump supply power is changed from PA1 to PA2 on an increased side by Δβ1. In addition, the pump supply power PA2 after an increase is stored as the learning value of the actuation limit power in the storage section of the ECU 50. At next power change timing t43, the pump supply power in the last energization and the learning value of the actuation limit power are compared. At this time, in the case where the pump supply power in the last energization is at most equal to the learning value of the actuation limit power, the pump supply power is not reduced even when it is determined that the high-pressure pump 20 is in the actuated state in the last energization, and the pump supply power in the last energization is maintained. Accordingly, intermittent occurrence of the non-actuation of the pump is avoided. As a result, the generation of the intermittent sound that is resulted from the non-actuation of the pump is suppressed.

In this embodiment, even after the pump supply power is learned (even in a period after t42 in FIG. 17), the pump actuation determination that is based on the detection result of the movement of the valve body is made as long as the execution of the sound reduction control is continued. The actuation limit power differs in accordance with an actuation environment, time degradation, or the like of the high-pressure pump 20. For example, regarding a temperature condition, resistance is increased as the temperature becomes higher. Thus, even at the same current value, the control valve 30 becomes less likely to be closed due to a temperature increase. Accordingly, in an execution period of the sound reduction control of the high-pressure pump 20, the pump actuation determination is continued after the pump supply power is learned. In this way, the learning value can be updated in the case where the high-pressure pump 20 is no longer actuated at the learning value.

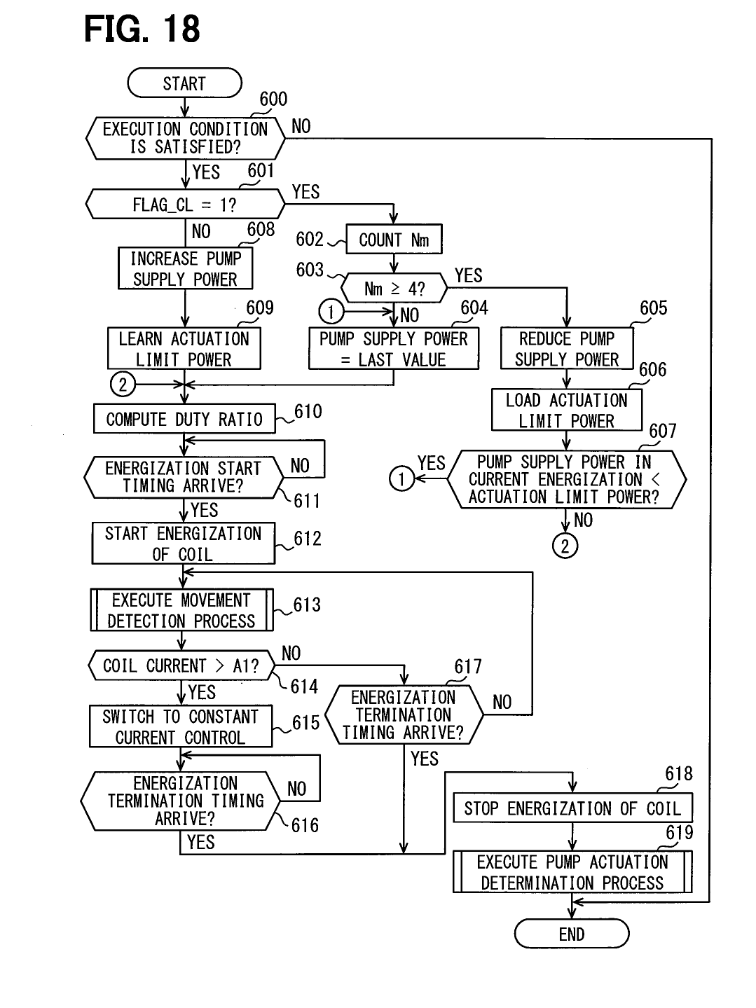

Next, the sound reduction control and the learning control of the actuation limit power of the high-pressure pump 20 of this embodiment will be described by using a flowchart in FIG. 18. The process is executed by a microcomputer of the ECU 50 at predetermined intervals. In the description of FIG. 18, the description of processes that are the same as those in above FIG. 7 is not made.

In FIG. 18, in 600 to 605, the microcomputer executes the same processes as 100 to 105 in above FIG. 7. In 605, the microcomputer sets the pump supply power in the current energization. In 606, the microcomputer loads the actuation limit power from the storage section. As the actuation limit power, the initial value Le1 is stored before the execution of learning, and the learning value is stored after the execution of learning. In 607, the microcomputer determines whether a value that is set as the pump supply power in the current energization is lower than the actuation limit power.

When the set value of the pump supply power in the current energization is at least equal to the actuation limit power, the microcomputer makes a positive determination in 607, and the process proceeds to 610. When the set value of the pump supply power in the current energization is lower than the actuation limit power, the microcomputer makes a negative determination in 607, advances the process to 604, and sets the last value as the pump supply power in the current energization. Then, the process proceeds to 610. That is, in the case where the pump supply power in the current energization is set with the pump supply power in the last energization as a reference and where the set value becomes lower than the actuation limit power, the reduction in the pump supply power is prohibited even when it is determined that the high-pressure pump 20 is actuated in the last energization.

On the other hand, when the microcomputer determines that the high-pressure pump 20 is not actuated in the last energization, a negative determination is made in 601, and the process proceeds to 608. In 608, the microcomputer sets a value that is obtained by increasing the last value by Δβ1 as the pump supply power in the current energization. In this embodiment, the processes in 601 to 608 correspond to the energization control section. In 609, the microcomputer stores the pump supply power after an increase (the set value of the pump supply power in the current energization) as the learning value of the actuation limit power in the storage section, and updates the value. Then, the microcomputer advances the process to 610. In this embodiment, the process in 609 corresponds to the learning section.

In 610 to 619, the microcomputer executes the same processes as 107 to 116 in above FIG. 7 and terminates the routine. In this embodiment, the process in 613 corresponds to the movement detection section, and the process in 619 corresponds to the actuation determination section.

According to the second embodiment that has been described in detail, in the case where the determination result of the pump actuation determination process differ between the last energization and the current energization, the pump supply power of the time in which it is determined that the high-pressure pump 20 is actuated is obtained and stored as the learning value of the actuation limit power of the high-pressure pump 20, and the pump supply power is controlled on the basis of the learning value. According to this configuration, the high-pressure pump 20 can be controlled at an optimum value for sound reduction by using the learning value. Accordingly, after the learning is performed once, a reduction operation of the pump supply power may not be performed. Thus, the repeated generation of the intermittent sound that is resulted from the non-actuation of the pump can be avoided.

In view of a fact that the actuation limit power is changed in accordance with the actuation environment, the time deterioration, or the like of the high-pressure pump 20, the pump actuation determination by the pump actuation determination process is continued in a period in which the pump supply power is controlled on the basis of the actuation limit power that is stored as the learning value. According to this configuration, even in the case where the currently stored learning value is deviated from the actual actuation limit power, the learning can be performed again by following an environmental change or the like, and thus continuation of the state where the high-pressure pump 20 is not actuated can be avoided.

In the case where the pump supply power is controlled at or near the actuation limit power of the high-pressure pump 20 and where the pump supply power is reduced, the pump supply power after a reduction possibly falls below the actuation limit power, and the high-pressure pump 20 cannot possibly be actuated. In view of this, in the case where the pump supply power is controlled at or near the actuation limit power of the high-pressure pump 20, more specifically, in the case where it is determined in 607 that the power that is reduced from the pump supply power in the last energization by the predetermined amount is lower than the actuation limit power, the reduction of the pump supply power by the power reduction control is prohibited. In this way, the non-actuation of the high-pressure pump 20 can be prevented, and, as a result, the intermittent generation of the collision sound that is resulted from the non-actuation of the pump can be suppressed.

### OTHER EMBODIMENTS

The present disclosure is not limited to the described contents of the above embodiments but may be implemented as follows, for example.

(a) In the above first embodiment, a configuration for prohibiting the reduction in the pump supply power by the power reduction control in the case where the pump supply power is controlled at or near the actuation limit power of the high-pressure pump 20 may be adopted. In the case where the pump supply power is reduced on the basis of the determination that the pump is actuated in the last energization regardless of whether the pump supply power in the current energization becomes lower than the actuation limit power, the intermittent sound that is resulted from the non-actuation of the pump is generated periodically (see FIG. 6(d)). In consideration of this point, by adopting the above configuration, the pump supply power can be maintained at the actuation limit power or higher power than that, and the periodical generation of the intermittent sound that is resulted from the non-actuation of the pump can be avoided. More specifically, in FIG. 6, it is determined whether the pump is not actuated in the last energization. When it is determined that the pump is not actuated, the pump supply power in next energization is increased by the predetermined amount (t51), and the reduction of the pump supply power is prohibited in a period at t51 onward. At this time, the pump supply power is controlled to be the actuation limit power or the higher power than that in a prohibition period of the power reduction.

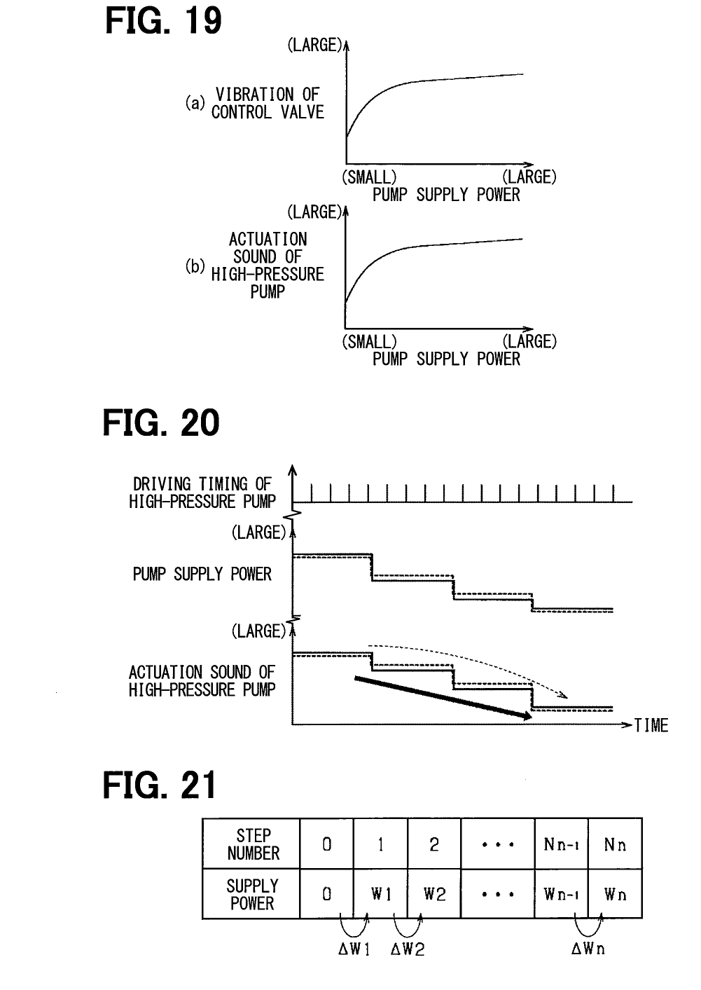

(b) In the embodiments, the change amount of the pump supply power in the power reduction control is set to the constant value Δα1, and the change amount of the pump supply power in the power increase control is set to the constant value Δβ1. However, these change amounts may be set variable. For example, the change amount of the pump supply amount on a reduced side or an increased side is set variable on the basis of the pump supply power. The vibration at a time that the first valve body 34 collides with the first stopper 36 differs in accordance with a magnitude of the pump supply power. As indicated in FIG. 19(a), the vibration of the control valve 30 becomes larger as the pump supply power is increased. In addition, a change amount of the vibration with respect to the power change amount is increased in a region where the pump supply power is low. The same can be said for the actuation sound of the high-pressure pump 20 (FIG. 19(b)). Accordingly, in the case where the change amount of the pump supply power is set to be the same for each of the power change intervals, as indicated by a broken line in FIG. 20, a change in the pump actuation sound is increased along with a lapse of time. In consideration of this point, in this embodiment, as indicated by a solid line in FIG. 20, in the region where the pump supply power is low, the change amount of the pump supply power in the current energization with respect to the pump supply power in the last energization is reduced. In this way, the change in the actuation sound is alleviated, and thus the sense of discomfort received by the occupant can be minimized as possible.

In this embodiment, relationships between step numbers and the pump supply power are defined in advance and stored as a table depicted in FIG. 21, for example. In the table, 0 to Nn (Nn is a positive integer) are set as the step numbers, and the pump supply power is set in correspondence with the step numbers. In addition, a larger value is set as the pump supply power as the step number increases. Furthermore, a difference between the pump supply power in the adjacent step numbers is smaller on a low power side than on a high power side (for example, ΔW1<ΔW2<ΔWn). In 105 in FIG. 7, instead of a configuration for setting the value that is obtained by reducing Δα1 from the pump supply power in the last energization is set as the pump supply power in the current energization, the pump supply power corresponding to the step number that is smaller by 1 than the step number in the last energization is set as the pump supply power in the current energization. In 106 in FIG. 7, instead of a configuration for setting the value that is obtained by increasing the pump supply power in the last energization by Δβ1 as the pump supply power in the current energization, the pump supply power corresponding to the step number that is larger by 1 than the step number in the last energization is set as the pump supply power in the current energization.

(c) In the above embodiments, the pump supply power is reduced or increased with the period after it is determined that the high-pressure pump 20 is not actuated until the actuation of the high-pressure pump 20 is detected for the multiple times as the one interval (the power change interval). However, a configuration for reducing or increasing the pump supply power at each driving timing of the high-pressure pump 20 may be adopted.

(d) In the configuration for reducing or increasing the pump supply power with the period after it is determined that the high-pressure pump 20 is not actuated until the actuation of the high-pressure pump 20 is detected for the multiple times as the power change interval, in consideration of relationships depicted in FIG. 19, duration of the power change interval can be changed in accordance with the pump supply power. At this time, the power change interval may be extended in the region where the pump supply power is low.

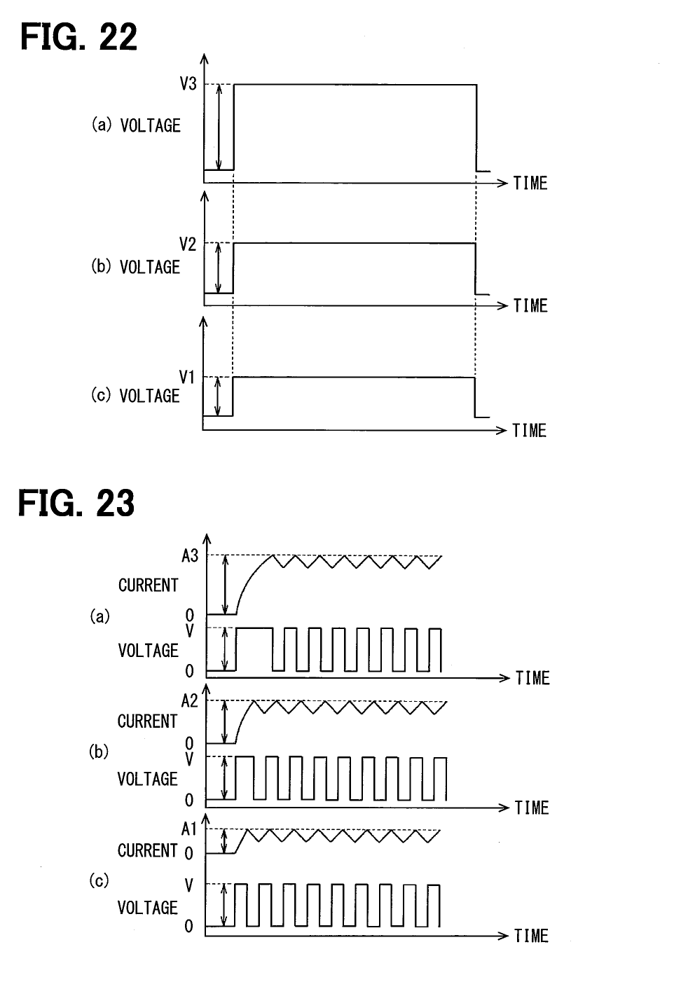

(e) In the above embodiment, the pump supply power is controlled by varying the duty ratio of the voltage that is applied to the coil 33 on the basis of the determination result of the actuation determination of the high-pressure pump 20 in the last energization. However, the configuration for controlling the pump supply power is not limited thereto. For example, as depicted in FIG. 22, a configuration for controlling the pump supply power by varying a voltage level on the basis of the determination result of the actuation determination of the high-pressure pump 20 in the last energization may be adopted. More specifically, in the power reduction control, the coil application voltage is reduced stepwise in an order of V3, V2, V1 at each power change interval. In the power increase control, the coil application voltage is increased stepwise in an order of V1, V2, V3 at each power change interval.

(f) Alternatively, a configuration for controlling the pump supply power by varying the current flowing through the coil 33 on the basis of the determination result of the actuation determination of the high-pressure pump 20 in the last energization may be adopted. More specifically, as depicted in FIG. 23, in the power reduction control, the upper limit guard of the coil current is reduced stepwise in an order of A3, A2, A1 at every power change interval. In the power increase control, the upper limit guard of the coil current is increased stepwise in an order of A1, A2, A3 at every power change interval. In order to control the coil current at the upper guard, the coil application voltage is turned ON/OFF by current feedback control while the current sensor 54 is monitored.

(g) As the configuration for controlling the pump supply power, a configuration for controlling the pump supply power by varying the coil application voltage and the coil current on the basis of the determination result of the actuation determination of the high-pressure pump 20 in the last energization may be adopted.

(h) In the above embodiment, the idle operation state is included as the execution condition of the sound reduction control, and the sound reduction control is executed when shifting to the idle operation state is made. However, the condition is not limited to the idle operation state. For example, a configuration for executing the sound reduction control in the case where the engine is operated in a predetermined low-speed low-load region that includes an idle operation region may be adopted. Alternatively, a configuration for executing the control in an entire region of an engine operation state may be adopted.

(i) As the execution condition of the sound reduction control, a configuration for including a condition that the requested discharge amount of the high-pressure pump 20 is at most equal to a predetermined value may be adopted. In the sound reduction control, the collision sound of the valve bodies 34, 37 with respect to the stoppers 36, 39 is reduced by extending a moving time of the valve body to the valve closing position. Meanwhile, as the requested discharge amount of the high-pressure pump 20 is increased, the energization start timing of the coil 33 needs to be advanced. Accordingly, in the case where the requested discharge amount of the high-pressure pump 20 is large, an energization time of the coil 33 is extended, and thus the coil 33 is possibly overheated. Accordingly, by adopting the above configuration, the sound reduction control can be executed while thermal protection of the coil 33 is achieved.

(j) As the execution condition of the sound reduction control, a configuration for including a condition that a voltage of the power supply 53 (a battery voltage) is at least equal to a predetermined value may be adopted. In the sound reduction control in the system, PWM control is executed at the beginning of the energization start of the coil 33. In this way, the moving time of the valve body to the valve closing position is extended. At this time, when the battery voltage is low, the supply power to the coil 33 is reduced, the valve body cannot be driven, and a fuel amount suited for the requested discharge amount cannot possibly be discharged from the high-pressure pump 20. By adopting the above configuration in consideration of such a point, shortage of fuel discharge of the high-pressure pump 20 that is resulted from power energy reduction to the control valve 30 can be suppressed.

(k) In the above second embodiment, as the learning control of the actuation limit power of the high-pressure pump 20, in the case where it is determined that the high-pressure pump 20 is not actuated in the last energization and that the high-pressure pump 20 is actuated in the current energization, the pump supply power in the current energization is obtained as the learning value of the actuation limit power, and the value is stored. A change is made thereto, and, in this embodiment, in the case where it is determined that the high-pressure pump 20 is actuated in the last energization and the high-pressure pump 20 is not actuated in the current energization, the pump supply power in the last energization is obtained as the learning value of the actuation limit power, and the value is stored.

(l) As the learning control of the actuation limit power of the high-pressure pump 20, a configuration for obtaining maximum power during the non-actuation of the high-pressure pump 20 as the learning value of the actuation limit power may be adopted. In the power reduction control of this configuration, in the case where it is determined that the high-pressure pump 20 is actuated in the last energization, the pump supply power in the current energization is computed by reducing a predetermined amount from the pump supply power in the last energization, and the computed value and the maximum power (the actuation limit power) during the non-actuation of the high-pressure pump 20 are compared. In the case where the computed value is higher than the actuation limit power, the coil 33 is energized at the computed value. On the other hand, in the case where the computed value is at most equal to the actuation limit power, the pump supply power in the last energization is again set as the pump supply power in the current energization.

(m) In the above second embodiment, the pump supply power is controlled by varying the duty ratio of the coil application voltage, and the pump supply power is obtained as the learning value of the actuation limit power. However, a voltage duty ratio may be obtained as the learning value. In addition, in the case where the pump supply power is controlled by varying a magnitude of the coil application voltage, a configuration for obtaining the voltage as the learning value of the actuation limit power may be adopted. Alternatively, in the case where the pump supply power is controlled by varying a magnitude of the coil current, a configuration for obtaining the coil current as the learning value of the actuation limit power may be adopted.

(n) In the above embodiments, the change amount Δα1 of the pump supply power in the power reduction control and the change amount A31 of the pump supply power in the power increase control are set to be the same. However, these may be different values. For example, in a configuration for obtaining the pump supply power in the current energization as the learning value in the case where it is detected that the pump is not actuated in the last energization and where it is detected that the pump is actuated in the current energization, the change amount Δβ1 may be set lower than the change amount Δα1. In this way, the supply power that causes the non-actuation of the pump can promptly be detected, and, in the subsequent power increase control, detection accuracy of the minimum power with which the pump can be actuated can be improved by reducing the power change amount at a time that the pump supply power is increased. In addition, in a configuration for obtaining the pump supply power in the last energization as the learning value in the case where it is detected that the pump is actuated in the last energization and where it is detected that the pump is not actuated in the current energization, a similar effect to the above can be obtained by setting the change amount Δα1 to be lower than the change amount Δβ1.

(o) In the above embodiments, the change in the current with respect to the drive command of the control valve 30 is detected on the basis of the current speed. However, a configuration for detecting the change in the current is not limited thereto. For example, a configuration for holding a maximum value of a measured value of the current, computing a change amount of a current measurement value with respect to the held value, and detecting the change in the current on the basis of the computed change amount in the ON period of the drive signal may be adopted.

(p) In the above embodiments, the actuation determination of the high-pressure pump 20 is made by detecting that the reduced tendency of the coil current occurs in the ON period of the drive signal. However, in view of a fact that the switching between the increased tendency and the reduced tendency of the current clearly appears as a bending point P1, a configuration for making the actuation determination of the high-pressure pump 20 by detecting that the coil current is shifted from the reduced tendency to an increase in the period may be adopted. More specifically, for example, presence or absence of the bending point P1 of the current is detected on the basis of the current value that is monitored in the ON period of the drive signal. When the bending point is present, it is determined that the high-pressure pump 20 is in the actuated state. In this configuration, not only the reduced tendency of the coil current, but also shifting to the increased tendency is further detected. Thus, determination accuracy of the movement of the valve body can be improved, and furthermore, accuracy of the actuation determination of the high-pressure pump 20 can be improved.

(q) As a configuration for detecting that the coil current is shifted from the reduced tendency to the increase in the ON period of the drive signal, a configuration for detecting that both of conditions including that the current speed falls below the determination value THa (<0) and that the current speed exceeds a determination value THb (<0) are satisfied may be adopted. At this time, the determination value THa and the determination value THb may be the same or different from each other.

(r) As the configuration for detecting that the coil current is shifted from the reduced tendency to the increase in the ON period of the drive signal, a configuration for detecting the shifting on the basis of a comparison result between the change amount of the current measurement value with respect to the held value of the maximum value and the determination value may be adopted. More specifically, a configuration for detecting that both of conditions including that the change amount of the current measurement value with respect to the held value exceeds the determination value and that the change amount falls below the determination value are satisfied may be adopted.

(s) In the above embodiments, the movement of the valve body with respect to the drive command is detected by detecting the change in the coil current with respect to the drive command of the valve opening/valve closing of the control valve 30. However, a method for detecting the movement of the valve body with respect to the drive command is not limited thereto. For example, the movement of the valve body with respect to the drive command is detected by detecting the change in the voltage that is applied to the coil 33 with respect to the drive command of the valve opening/valve closing of the control valve 30.

A specific description will be made on a case where the movement of the valve body with respect to the drive command is detected on the basis of the change in the voltage applied to the coil 33 by using FIG. 2A. In the system, a voltage sensor for detecting a voltage between an input terminal T1 and an output terminal T2 of the coil 33 is provided. In the ON period of the drive signal of the control valve 30, a detection value of the voltage sensor is monitored, and it is determined whether a behavior in which a change amount (a change width) of the voltage becomes at least equal to a predetermined value (a voltage change that is observed near timing t12) appears separately from a voltage change by the duty control. In a period from switching of the drive signal to OFF to a lapse of a predetermined time, the voltage detected by the voltage sensor is monitored, and, as the change in the voltage appeared by a change in inductance, bending points P2, P3 of the voltage are detected, for example. In the case where all of these behaviors are detected, the first valve body 34 shows the normal movement with respect to the drive command, and thus such a determination that the high-pressure pump 20 is actuated is made. On the other hand, in the case where at least one of these behaviors is not detected, the first valve body 34 does not show the normal movement with respect to the drive command. Thus, such a determination that the high-pressure pump 20 is not actuated normally is made.

Any one or two of the above three voltage change behaviors may be set as detection targets, and it may be determined whether the behaviors of the detection targets are detected. In this way, the actuation determination of the high-pressure pump 20 may be made.

(t) A configuration for including a displacement sensor that detects displacement of the valve body of the control valve 30 may be adopted, and a configuration for detecting the movement of the valve body with respect to the drive command of the valve opening or the valve closing by detecting the displacement of the valve body with the displacement sensor may be adopted. As the displacement sensor, a sensor that is provided at a position to oppose the end of the first valve body 34 and that can detect a separation distance with respect to the valve closing position (the abutment position against the first stopper 36) may be used.

More specifically, in the ON period of the drive signal of the control valve 30, displacement X of the first valve body 34 is monitored by the displacement sensor, and it is determined whether the displacement X of the first valve body 34 falls within a predetermined range that includes the valve closing position CL1. In addition, in a period from switching of the drive signal to OFF to a lapse of a predetermined time, the displacement X of the first valve body 34 is monitored by the displacement sensor, and it is determined whether the displacement X of the first valve body 34 falls within a predetermined range that includes the valve opening position OP1. Then, when both of two determination results are positive determinations, such a determination that the high-pressure pump 20 is actuated is made. On the other hand, when at least one of the two determination results is a negative determination, such a determination that the high-pressure pump 20 is not actuated is made. The actuation determination of the high-pressure pump 20 may be made on the basis of either one of these two determination results.

(u) The displacement sensor is not limited to have the above configuration. For example, a contact point sensor is attached as the displacement sensor to a portion of the first stopper 36, an ON signal is outputted when the first valve body 34 abuts against the first stopper 36, and an OFF signal is outputted when the first valve body 34 separates from the first stopper 36. Then, the displacement of the valve body is detected by the ON/OFF signal of the contact point sensor. Alternatively, a conduction sensor is attached as the displacement sensor to the valve opening position of the first valve body 34, an ON signal is outputted when the first valve body 34 is held at the valve opening position, and an OFF signal is outputted when the first valve body 34 is displaced from the valve opening position. Then, a configuration for detecting the displacement of the valve body by the ON/OFF signal of the conduction sensor may be adopted.

(v) A configuration for providing a sensor that detects displacement of the second valve body 37 instead of the sensor that detects the displacement of the first valve body 34 and making the actuation determination of the high-pressure pump 20 on the basis of the displacement detected by the sensor may be adopted.

(w) A configuration for including a vibration sensor that detects the vibration generated at a time that the valve bodies (the first valve body 34 and the second valve body 37) of the control valve 30 respectively collide with the stoppers 36, 39 is adopted, and the movement of the valve body with respect to the drive command of the control valve 30 is detected by detecting the vibration during the collision of the valve bodies 34, 37 with the stoppers 36, 39 by the vibration sensor. In addition, the actuation determination of the high-pressure pump 20 is made on the basis of a detection result.

More specifically, for example, a standard deviation a of a detection value (amplitude) of the vibration sensor is computed, and the actuation determination of the high-pressure pump 20 is made by comparing between the computed standard deviation a and the determination value. In the case where the high-pressure pump 20 can be actuated, the first valve body 34 and the second valve body 37 are displaced in conjunction with the drive command of the control valve 30. Thus, as depicted in FIG. 2A, the vibration is generated at (1) the timing t12 at which the first valve body 34 collides with the first stopper 36 in conjunction with the valve closing command, (2) the timing t13 at which the first valve body 34 collides with the second valve body 37 in conjunction with the valve opening command, and (3) the timing t15 at which the second valve body 37 collides with the second stopper 39, and the standard deviation a of the amplitude becomes larger than the determination value. On the other hand, the vibration is not generated in the case where the high-pressure pump 20 is not actuated (see FIG. 3). Thus, the standard deviation a of the amplitude becomes substantially 0. By using this event, the actuation determination of the high-pressure pump 20 is made.

(x) Instead of a configuration for detecting the movement of the valve body with respect to the drive command on the basis of the standard deviation a of the amplitude of the vibration that is detected by the vibration sensor, a configuration for detecting the movement of the valve body with respect to the drive command on the basis of a comparison result between the amplitude and the determination value may be adopted. At this time, the determination that that the pump is actuated is made when the amplitude (>0) is larger than the determination value, and the determination that the pump is not actuated is made when the amplitude is at most equal to the determination value. Alternatively, a configuration for computing an integral value of the amplitude per single vibration and detecting the movement of the valve body with respect to the drive command on the basis of the computed integral value may be adopted. At this time, the integral value and the determination value are compared. The determination that the pump is actuated is made when the integral value is larger than the determination value, and the determination that the pump is not actuated is made when the integral value is at most equal to the determination value.

(y) In the above embodiments, the movement of the valve body with respect to the drive command is detected by detecting any of the change in the current flowing through the coil 33, the change in the voltage applied to the coil 33, the displacement amount of the valve body, and the vibration of the control valve 30. However, a configuration for detecting the movement of the valve body with respect to the drive command by detecting two or more of these may be adopted. For example, in the case where it is determined that the speed of the current value (the differential value) that is detected by the current sensor 54 falls below the determination value THa and that the change width of the voltage value that is detected by the voltage sensor 57 is at least equal to the predetermined value in the ON period of the drive signal of the control valve 30, the valve closing determination flag FLAG_CL is set to 1. On the other hand, in the case where either that the speed of the current value (the differential value) that is detected by the current sensor 54 falls below the determination value THa or that the change width of the voltage value that is detected by the voltage sensor 57 is at least equal to the predetermined value is not detected, the valve closing determination flag FLAG_CL remains 0.

(z) In the above embodiments, a case where the present disclosure is applied to the fuel supply system that includes the control valve 30 having the two valve bodies (the first valve body 34 and the second valve body 37) has been described. However, the present disclosure may be applied to a fuel supply system that includes a control valve having only one valve body. More specifically, the present disclosure is applied to a system having a valve body configured that the control valve is disposed as the valve body in a fuel suction passage that communicates with a pressurizing chamber, can be displaced in an axial direction by switching between energization and non-energization of the coil 33, and supplies/blocks fuel to/from the pressurizing chamber in conjunction with displacement. Also in this configuration, the movement of the valve body with respect to the drive command can be detected on the basis of at least one of the change in the current flowing through the coil 33, the change in the voltage applied to the coil 33, the displacement amount of the valve body, and the vibration of the control valve 30. Thus, the actuation determination of the high-pressure pump 20 can be made on the basis of the movement.

(aa) In the above embodiments, the gasoline engine is used as the internal combustion engine. However, a configuration for using a diesel engine may be adopted. That is, the present disclosure may be embodied as a control device for a common rail type fuel supply system of the diesel engine.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A control device for a high-pressure pump that is applied to a high-pressure pump including: a plunger that reciprocates in conjunction with rotation of a rotational shaft so as to be able to change a volume of a pressurizing chamber; and a control valve that has a valve body disposed in a fuel suction passage that communicates with the pressurizing chamber and supplies/blocks fuel to/from the pressurizing chamber by displacing the valve body in an axial direction by energization control with respect to an electromagnetic section, and the control device for a high-pressure pump adjusting a fuel discharge amount of the high-pressure pump by switching between a valve opening and a valve closing of the control valve by the energization control, the control device for a high-pressure pump comprising:
a movement detection section detecting movement of the valve body with respect to a drive command of the control valve;
an actuation determination section making an actuation determination of the high-pressure pump on the basis of a detection result of the movement detection section; and
an energization control section executing sound reduction control that reduces actuation sound of the high-pressure pump by controlling supply power supplied to the electromagnetic section on the basis of a determination result of the actuation determination in previous energization by the actuation determination section.

2. The control device for a high-pressure pump according to claim 1, wherein the movement detection section detects the movement of the valve body with respect to the drive command by detecting at least one of a change in a current flowing through the electromagnetic section, a change in a voltage applied to the electromagnetic section, a displacement amount of the valve body, and a vibration of the control valve.

3. The control device for a high-pressure pump according to claim 1, wherein the energization control section executes, as the sound reduction control, power reduction control controlling the supply power with power that is reduced by a predetermined amount from the supply power in the previous energization during later energization than the previous energization in the case where it is determined by the actuation determination section that the high-pressure pump is actuated in the previous energization.

4. The control device for a high-pressure pump according to claim 3, wherein the energization control section prohibits reduction in the supply power by the power reduction control in the case where the supply power is controlled at or near actuation limit power of the high-pressure pump.

5. The control device for a high-pressure pump according to claim 1, wherein the energization control section executes, as the sound reduction control, power increase control for controlling the supply power with power that is increased by a predetermined amount from the supply power in the previous energization during the later energization than the previous energization in the case where it is determined by the actuation determination section that the high-pressure pump is not actuated in the previous energization.

6. The control device for a high-pressure pump according to claim 1, wherein the energization control section executes, as the sound reduction control: power reduction control for controlling the supply power with power that is reduced by a predetermined amount from the supply power in the previous energization during later energization than the previous energization in the case where it is determined by the actuation determination section that the high-pressure pump is actuated in the previous energization; and power increase control for controlling the supply power with power that is increased by a predetermined amount from the supply power in the previous energization during the later energization than the previous energization in the case where it is determined by the actuation determination section that the high-pressure pump is not actuated in the previous energization due to execution of the power reduction control.

7. The control device for a high-pressure pump according to claim 1, further comprising
a learning section storing the supply power of time in which it is determined by the actuation determination section that the high-pressure pump is actuated as a learning value of the actuation limit power of the high-pressure pump in the case where a determination result by the actuation determination section differs between the previous energization and the later determination than the previous energization, wherein
the energization control section controls the supply power on the basis of the actuation limit power that is stored by the learning section.

8. The control device for a high-pressure pump according to claim 7, wherein the actuation determination of the high-pressure pump by the actuation determination section is continuously made in a period in which the supply power is controlled on the basis of the actuation limit power that is stored by the learning section.

9. The control device for a high-pressure pump according to claim 1, wherein
as the sound reduction control, the energization control section controls the supply power by setting power that is increased or reduced by a predetermined change amount from the supply power in the previous energization as the supply power in the later energization than the previous energization, and
executes variable control of the change amount in accordance with the supply power.

10. The control device for a high-pressure pump according to claim 9, wherein the change amount is reduced as the supply power becomes low.

11. The control device for a high-pressure pump according to claim 1, wherein
the energization control section controls the supply power in the sound reduction control by increasing or reducing the supply power in the later energization than the previous energization with respect to the supply power in the previous energization, and
the supply power is changed with a period after it is determined by the actuation determination section that the high-pressure pump is not actuated until actuation of the high-pressure pump is detected for multiple times by the actuation determination section as one interval.

12. The control device for a high-pressure pump according to claim 1, wherein
the movement detection section detects the movement of the valve body with respect to the drive command by detecting the change in the current flowing through the electromagnetic section, and
the energization control section controls the supply power by controlling the voltage applied to the electromagnetic section in the sound reduction control.

13. The control device for a high-pressure pump according to claim 1, the control device for a high-pressure pump energizing the electromagnetic section in a volume reduction stroke for reducing the volume of the pressurizing chamber, adjusting the fuel discharge amount of the high-pressure pump on the basis of start timing of the energization, the control device for a high-pressure pump further comprising:
a time computation section computing a valve closing required time that is required for the valve body to be displaced to a position at which a supply of the fuel to the pressurizing chamber is blocked from the drive command of the control valve on the basis of the supply power; and
a timing computation section computing energization start timing for energizing the electromagnetic section in the volume reduction stroke on the basis of the valve closing required time that is computed by the time computation section.

14. The control device for a high-pressure pump according to claim 1, wherein
the energization control section changes the supply power to an increased side in the later energization than the previous energization in the case where it is determined by the actuation determination section that the high-pressure pump is not actuated in the previous energization, and includes an abnormality diagnosis section executing abnormality diagnosis of the high-pressure pump on the basis of the supply power is provided.
